(19) United States
(12) Patent Application Publication
(10) Pub. No.: US 2017/0366464 A1
(43) Pub. Date: Dec. 21, 2017

(54) INFORMATION PROCESSING METHOD AND INFORMATION PROCESSING DEVICE

(71) Applicant: FUJITSU LIMITED, Kawasaki-shi (JP)

(72) Inventor: Satoru NISHIMAKI, Kawasaki (JP)

(73) Assignee: FUJITSU LIMITED, Kawasaki-shi (JP)

(21) Appl. No.: 15/487,518

(22) Filed: Apr. 14, 2017

(30) Foreign Application Priority Data
Jun. 20, 2016 (JP) 2016-122151

(51) Int. Cl. H04L 12/833; H04L 12/823; H04L 12/851

(52) U.S. Cl. CPC H04L 47/2458; H04L 47/2483; H04L 47/32

(57) ABSTRACT

An information processing method executed by a processor included in a computer, the computer including a memory that stores a plurality of flow entries in each of which a packet condition for choosing a packet, a processing content corresponding to the packet, and a type of the processing content are associated with one another, the information processing method includes choosing, from the flow entries, one or more candidate flow entries respectively including a type different from the type included in a new flow entry, when storing the new flow entry; detecting, from among the one or more candidate flow entries, a competitive flow entry having the processing content different from that of the new flow entry based on the packet condition; and notifying another information processing device coupled to the information processing device of a result of the detecting.

### CROSS-REFERENCE TO RELATED APPLICATION

This application is based upon and claims the benefit of priority of the prior Japanese Patent Application No. 2016-122151, filed on Jun. 20, 2016, the entire contents of which are incorporated herein by reference.

### FIELD

The embodiments discussed herein are related to an information processing method and an information processing device.

### BACKGROUND

Network devices (switches, for example) of the related art each have functions such as selection of paths and transfer of data. Therefore, as for a maintenance work for network devices, such as changing of settings, a form of being performed for each of network devices or each of types of network device is adopted, in general. Furthermore, a good deal of effort is put into a case of changing a configuration of a network.

In recent years, there has been advent of a technology called software defined networking (SDN) that intensively controls functions of network devices by using a single piece of software and that enables configurations of networks, settings of network devices, and so forth to be flexibly and dynamically changed.

According to the SDN, by intensively managing functional control of network devices at a single point by use of software, it is possible to set operations to be performed by respective network devices, as desired. In general, by registering, in an SDN controller, flow entries in which handlings of packets are defined, the SDN controller controls operations in the respective network devices.

However, in a case where, in an environment in which the SDN controller to centrally manage in this way is used, pieces of control application (pieces of application to control communication by using the SDN controller) are intended to be deployed, for example, an inconvenience occurs regarding an operation of a network device, in some cases. The trouble of having to check flow entries in order to forestall it is cumbersome. As the related art, Japanese Laid-open Patent Publication No. 2016-15672, Japanese Laid-open Patent Publication No. 2002-176431, and so forth are disclosed, for example.

In view of the above, it is desirable that it is possible to reduce a load on processing for detecting competition associated with addition of a flow entry.

### SUMMARY

According to an aspect of the invention, an information processing method executed by a processor included in a computer, the computer including a memory that stores a plurality of flow entries in each of which a packet condition for choosing a packet, a processing content corresponding to the packet, and a type of the processing content are associated with one another, the information processing method includes choosing, from the flow entries, one or more candidate flow entries respectively including a type different from the type included in a new flow entry, when storing the new flow entry; detecting, from among the one or more candidate flow entries, a competitive flow entry having the processing content different from that of the new flow entry based on the packet condition; and notifying another information processing device coupled to the information processing device of a result of the detecting.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network;

FIG. 2 is a diagram illustrating an example of an operation based on a flow table;

FIG. 3 is a diagram illustrating an example in which flow entries compete with each other;

FIG. 4 is a diagram illustrating a comparison between a new flow entry and already-registered flow entries;

FIG. 5 is a diagram illustrating determination patterns of competition;

FIG. 6A is a diagram illustrating a detection processing flow;

FIG. 6B is a diagram illustrating the detection processing flow;

FIG. 7A is a diagram illustrating a processing flow for determining a relationship between packet conditions;

FIG. 7B is a diagram illustrating the processing flow for determining a relationship between packet conditions;

FIG. 8A is a diagram illustrating examples of respective tables;

FIG. 8B is a diagram illustrating examples of a flow table and a type table;

FIG. 9A is a diagram illustrating an example of a module configuration of an SDN controller;

FIG. 9B is a diagram illustrating an example of a module configuration of an inspection device;

FIG. 10 is a diagram illustrating a preprocessing flow;

FIG. 11 is a diagram illustrating a main processing flow;

FIG. 12 is a diagram illustrating determination patterns of competition;

FIG. 13 is a diagram illustrating a detection processing flow;

FIG. 14 is a diagram illustrating a determination processing flow based on a first determination method;

FIG. 15 is a diagram illustrating a determination processing flow based on a second determination method;

FIG. 16 is a diagram illustrating a determination processing flow based on a third determination method;

FIG. 17 is a diagram illustrating examples of respective tables in a second embodiment;

FIG. 18 is a diagram illustrating a preprocessing flow;

FIG. 19A is a diagram illustrating a main processing flow;

FIG. 19B is a diagram illustrating the main processing flow;

FIG. 19C is a diagram illustrating the main processing flow;

FIG. 19D is a diagram illustrating the main processing flow; and

FIG. 20 is a functional block diagram of a computer.

### DESCRIPTION OF EMBODIMENTS

### First Embodiment

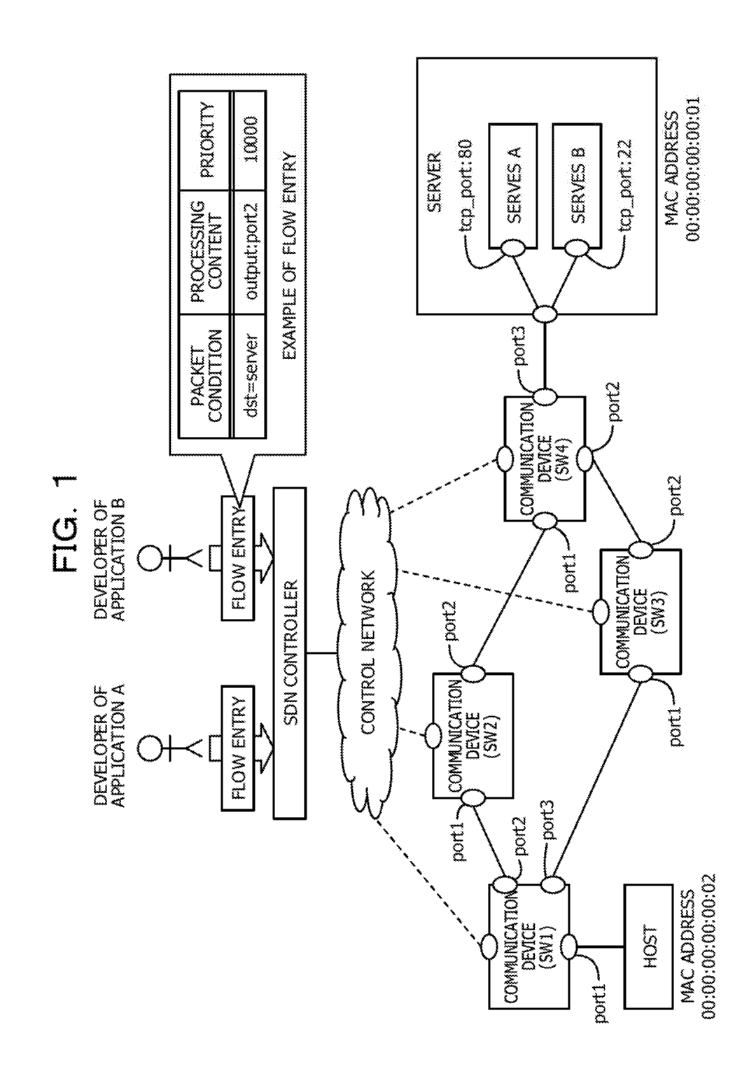

In the SDN, functions of an entire network are intensively controlled by an SDN controller by using a protocol such as, for example, OpenFlow. In an example illustrated in FIG. 1, a user serving as a developer of a control application or a network administrator operates a user terminal of the user oneself, thereby setting, in the SDN controller, functional control in network devices.

Since the SDN controller provides an open application programming interface (API), the network may be controlled by using the control application. In that case, the control application sets, in the SDN controller, the functional control in the network devices.

In the example illustrated in FIG. 1, the network serving as a control target includes four communication devices, a host, and a server. The communication devices illustrated in FIG. 1 are switches. The communication devices in this example are examples of network devices, and other types of network device (routers, for example) may be set to control targets.

Settings for functional control, performed on the network devices, are performed in units of flow entries. Upon receiving a flow entry, the SDN controller registers the relevant flow entry in a flow table corresponding to a corresponding one of the network devices. Usually, the flow table includes flow entries. In each of the flow entries, a packet condition, a processing content, and a priority are set. The packet condition is a condition for choosing a packet to serve as a processing target in a corresponding one of the network devices. Furthermore, the packet condition is a condition for identifying a communication flow. The packet condition is called a match condition, in some cases. The processing content defines processing to be performed on a packet conformable to the packet condition. The priority indicates, by use of a magnitude of a numerical value, a priority order related to an application of the relevant condition and the relevant processing content.

The flow table is transmitted to a corresponding one of the network devices via a control network by the SDN controller. The corresponding one of the network devices operates based on the received flow table. An operation for transferring a packet is performed, for example.

The communication devices are coupled via ports thereof, as illustrated in FIG. 1. The server provides a service A to use a TCP port having the number of “80” and a service B to use a TCP port having the number of “22”. In the example of FIG. 1, a MAC address of the host is “00:00:00:00:00:02”. A MAC address of the server is “00:00:00:00:00:01”.

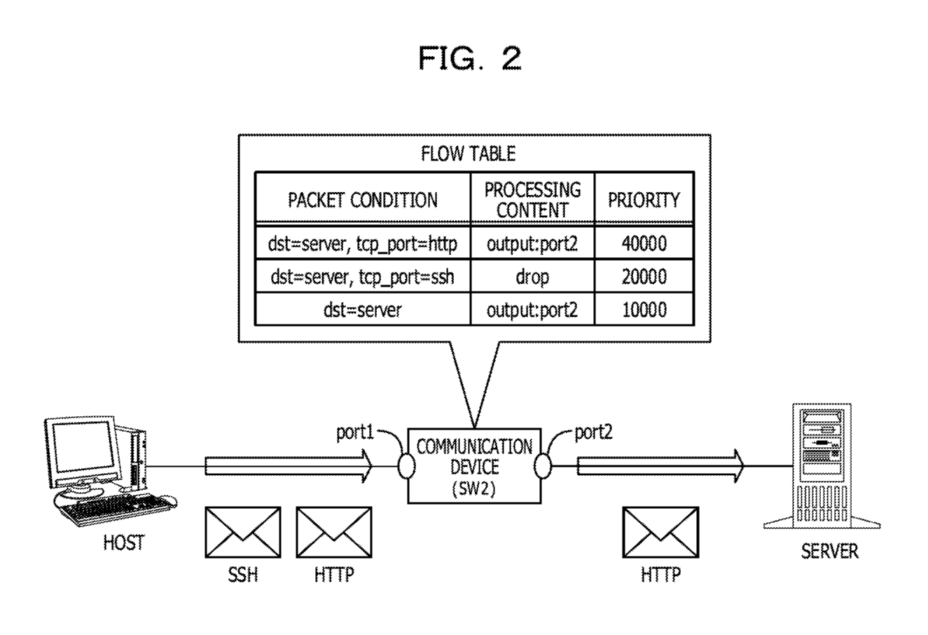

FIG. 2 illustrates an example of an operation based on a flow table. Upon receiving a packet, a corresponding one of the communication devices (switches) extracts, from the header information of the received packet, data to be used for determining a packet condition. In addition, the corresponding one of the communication devices (switches) searches, within a corresponding one of the flow tables, for a flow entry matched with the packet condition. At this time, conformance to the packet condition is determined in an order starting from a flow entry having a higher priority. In the example of FIG. 2, determination targets are identified in order of a first flow entry, a second flow entry, and a third flow entry.

In addition, the corresponding one of the communication devices (switches) performs a processing content set in a flow entry with which the packet condition is matched first. Accordingly, a flow entry having a priority lower than that of the relevant flow entry is ignored.

The packet condition includes one or more lower-level conditions. In a case of including the lower-level conditions, if all the lower-level conditions are satisfied, it is determined that the packet condition is satisfied. In other words, the packet condition is defined by a logical product of the lower-level conditions. The lower-level conditions are related to parameters such as, for example, a transmission source MAC address, a destination MAC address, the type of Ethernet (registered trademark), a transmission source IP address, a destination IP address, a transmission source transmission control protocol (TCP) port number, a destination TCP port number, and a number of a physical port through which the relevant packet is received. A Parameter not set as a lower-level condition is ignored. While, here, an example of the TCP is illustrated, the same applies to a case of a user datagram protocol (UDP).

In this example, in a case where a destination MAC address set in a packet received by the corresponding one of the communication devices (SW2) corresponds to the server and a destination TCP port number corresponds to a port for a hypertext transfer protocol (HTTP), the relevant packet is delivered by a port 2 of the corresponding one of the communication devices (SW2). In other cases, if the destination MAC address set in the packet received by the corresponding one of the communication devices (SW2) corresponds to the server and the destination TCP port number corresponds to a port for a secure shell (SSH), the packet is discarded. Furthermore, in other cases, if the destination MAC address set in the packet received by the corresponding one of the communication devices (SW2) corresponds to the server, the relevant packet is delivered by the port 2 of the corresponding one of the communication devices (SW2). In other words, a packet for which the destination MAC address corresponds to the server and the destination TCP port number corresponds to none of the port for the HTTP and the port for the SSH turns out to be delivered by the port 2. “drop” illustrated in FIG. 2 means discarding, and “output” means transferring.

In, for example, a case where control applications independently set flow entries, “competition between flow entries” occurs in some cases. The term “competition between flow entries” means that, in a case of focusing on two or more flow entries, a state in which, under the influence of one of the flow entries, none of operations based on the other flow entries are performed is produced. In this case, none of intentions to set the other flow entries turn out to be reflected.

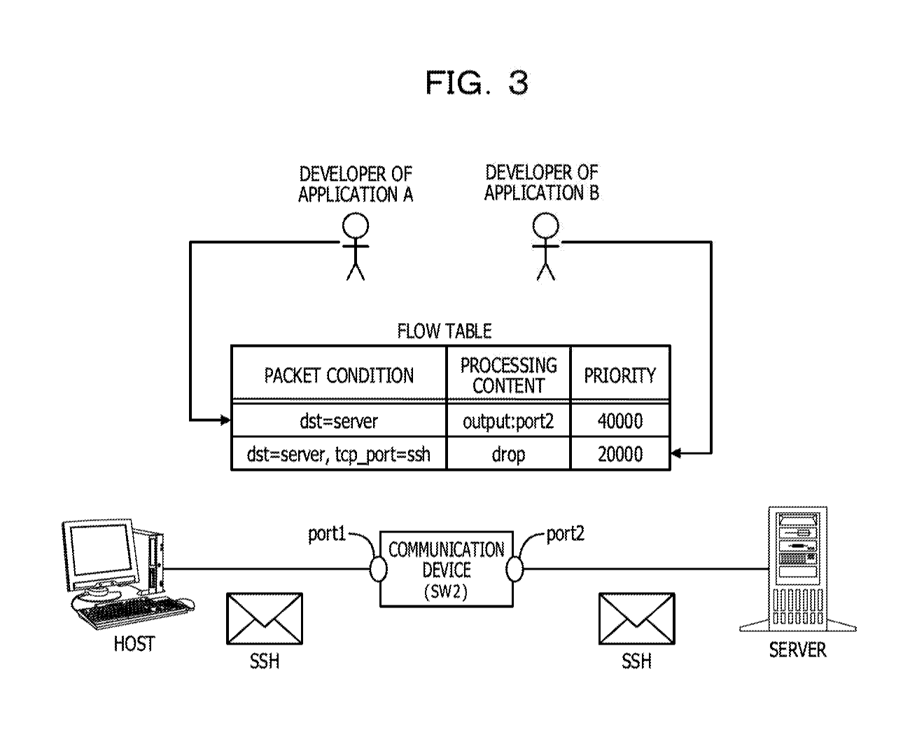

FIG. 3 illustrates an example in which flow entries compete with each other. In this example, a first flow entry is set by an application A. A second flow entry is set by an application B. The application A and the application B each correspond to the above-mentioned control application.

The second flow entry is set based on the application B's intention to discard a received packet in a case where a destination MAC address set in the relevant packet corresponds to the server and a TCP port number corresponds to a port for the SSH.

However, the first flow entry having a higher priority is defined as a determination target first. In a case where the destination MAC address set in the received packet corresponds to the server, the other conditions are ignored, and the relevant packet is delivered by the port 2 of the corresponding one of the communication devices (SW2). In other words, a packet for which the TCP port number corresponds to the port for the SSH is delivered by the port 2.

In this example, a state in which no operation based on the second flow entry is performed under the influence of the first flow entry is produced. In other words, the first flow entry and the second flow entry compete with each other.

In the present embodiment, in the SDN controller or an inspection device, such “competition between flow entries” is sensed. In what follows, an example in which the SDN controller mainly senses the “competition between flow entries” will be described. An example of causing to operate in this way is not limited to the OpenFlow. The present embodiment may be applied to another protocol that operates in the same way as the OpenFlow.

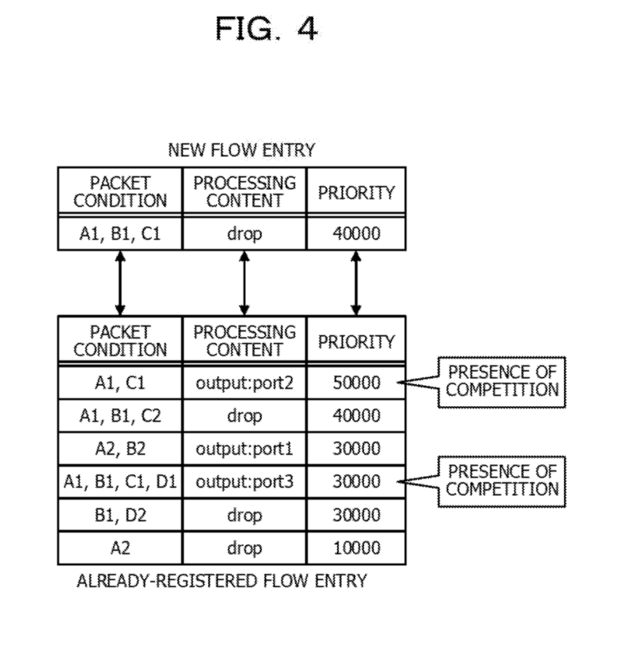

Specifically, as illustrated in FIG. 4, at a point of time of receiving a new flow entry, the SDN controller compares each of already-registered flow entries related to a common communication device and the new flow entry with each other, thereby determining the presence or absence of competition.

The lower-level condition of “dst=server” (indicating that a destination MAC address corresponds to the server) is expressed by “A1”. The lower-level condition of “dst=host” (indicating that the destination MAC address corresponds to the host) is expressed by “A2”. The lower-level condition of “src=host” (indicating that a transmission source MAC address corresponds to the host) is expressed by “B1”. The lower-level condition of “src=server” (indicating that the transmission source MAC address corresponds to the server) is expressed by “B2”. The lower-level condition of “tcp_port=80” (indicating that a TCP port number corresponds to a port for the HTTP) is expressed by “C1”. The lower-level condition of “tcp_port=22” (indicating that the TCP port number corresponds to a port for the SSH) is expressed by “C2”.

A first already-registered flow entry and the new flow entry, illustrated in FIG. 4, compete with each other. The reason is that even if the new flow entry is registered in a flow table, no operation based on the new flow entry is performed under the influence of the first already-registered flow entry.

A fourth already-registered flow entry and the new flow entry, illustrated in FIG. 4, compete with each other. The reason is that in a case the new flow entry is registered in the flow table, no operation based on the fourth already-registered flow entry turns out to be performed under the influence of the new flow entry.

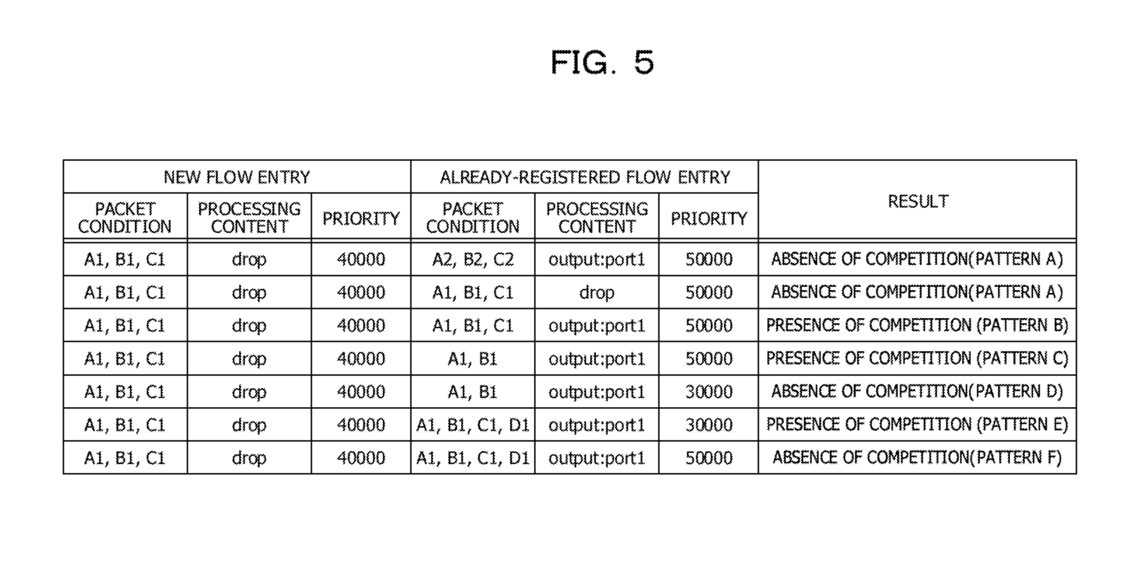

Here, before describing an example according to the present embodiment, an example of processing for sensing competition between flow entries will be described. Determination patterns in this example of processing are illustrated in FIG. 5 by using a table form. Records each correspond to one example of determination.

In a first record, a packet condition of a new flow entry and a packet condition of an already-registered flow entry are not consistent with each other, and furthermore, no inclusion relation is included therein. In such a case, since a packet to serve as a processing target is different, no competition occurs. This example corresponds to an after-mentioned pattern A of determination.

In a second record, the packet condition of the new flow entry and a packet condition of an already-registered flow entry are consistent with each other. In this regard, however, processing contents of the two flow entries are equal to each other. Actually, a processing content in the already-registered flow entry having a higher priority is executed. However, this execution is practically equal to execution of the processing content in the new flow entry having a lower priority. Accordingly, in such a case, it is assumed that no competition occurs. This example corresponds to the after-mentioned pattern A of determination.

In a third record, the packet condition of the new flow entry and a packet condition of an already-registered flow entry are consistent with each other. In addition, since processing contents of the two flow entries are different from each other, no processing content of one of the two flow entries turns out to be executed. In this example, since the already-registered flow entry is prioritized, the processing content of “drop” (discarding) set in the new flow entry is not performed. In other words, competition occurs. This example corresponds to an after-mentioned pattern B of determination.

In a fourth record, a packet condition of an already-registered flow entry includes the packet condition of the new flow entry. In addition, the already-registered flow entry has a higher priority. Accordingly, a packet matched with the packet condition of the new flow entry is first determined to be matched with the packet condition of the already-registered flow entry and becomes a processing target based on the already-registered flow entry. Since a processing content of “output:port1” (delivery from a port 1) of the already-registered flow entry is different from the processing content of “drop” (discarding) of the new flow entry, the processing content of the new flow entry is not practically executed. Accordingly, in such a case, competition occurs. This example corresponds to an after-mentioned pattern C of determination.

In a fifth record, in the same way as in a case of the fourth record, a packet condition of an already-registered flow entry includes the packet condition of the new flow entry. In the same way, a processing content of “output:port1” (delivery from the port 1) of the already-registered flow entry is different from the processing content of “drop” (discarding) of the new flow entry. However, in a case of the fifth record, the new flow entry has a higher priority. Accordingly, the processing content of the new flow entry is executed on a packet matched with the packet condition of the new flow entry. In this case, since the processing contents of both the flow entries are executed in some cases, no competition occurs. This example corresponds to an after-mentioned pattern D of determination.

In a sixth record, the packet condition of the new flow entry includes a packet condition of an already-registered flow entry. “D1” means a lower-level condition of “ingress_port=1” (meaning that a number of a physical port that performed reception is “1”). In addition, the new flow entry has a higher priority. Accordingly, a packet matched with the packet condition of the already-registered flow entry is first determined to be matched with the packet condition of the new flow entry and becomes a processing target based on the new flow entry. Since the processing content of “drop” (discarding) of the new flow entry is different from a processing content “output:port1” (delivery from the port 1) of the already-registered flow entry. Therefore, the processing content of the already-registered flow entry is not practically executed. Accordingly, in such a case, competition occurs. This example corresponds to an after-mentioned pattern E of determination.

In a seventh record, in the same way as in a case of the sixth record, the packet condition of the new flow entry includes a packet condition of an already-registered flow entry. In the same way, the processing content of “drop” (discarding) of the new flow entry is different from a processing content of “output:port1” (delivery from the port 1) of the already-registered flow entry. However, in a case of the seventh record, the already-registered flow entry has a higher priority. Accordingly, the processing content of the already-registered flow entry is executed on a packet matched with the packet condition of the already-registered flow entry. In this case, since the processing contents of both the flow entries are executed in some cases, no competition occurs. This example corresponds to an after-mentioned pattern F of determination.

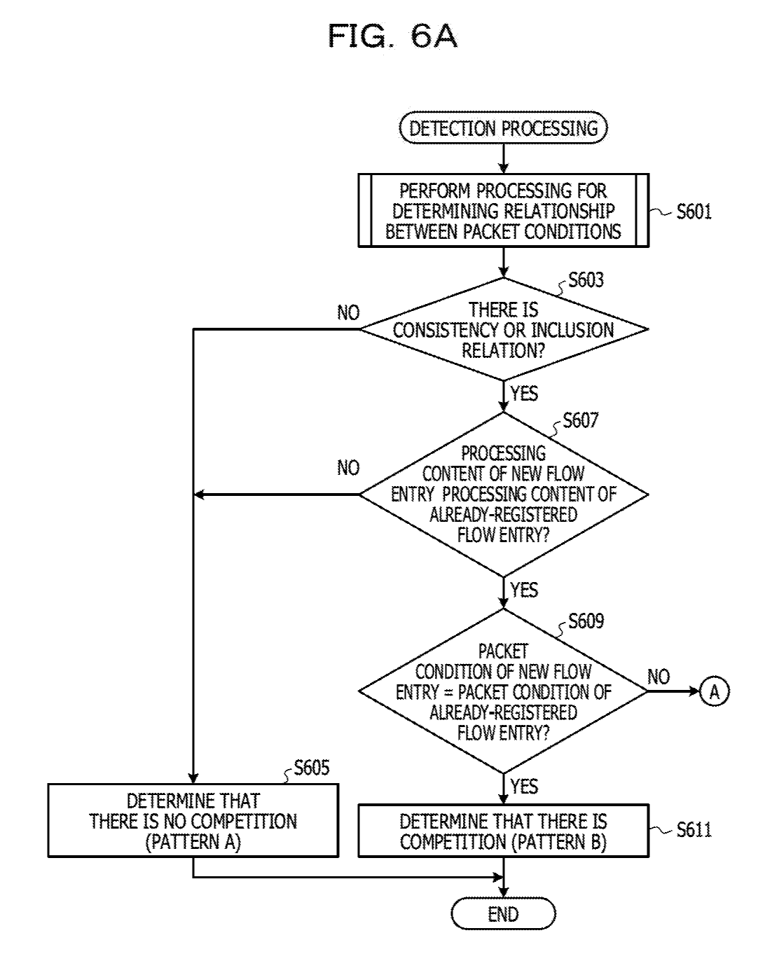

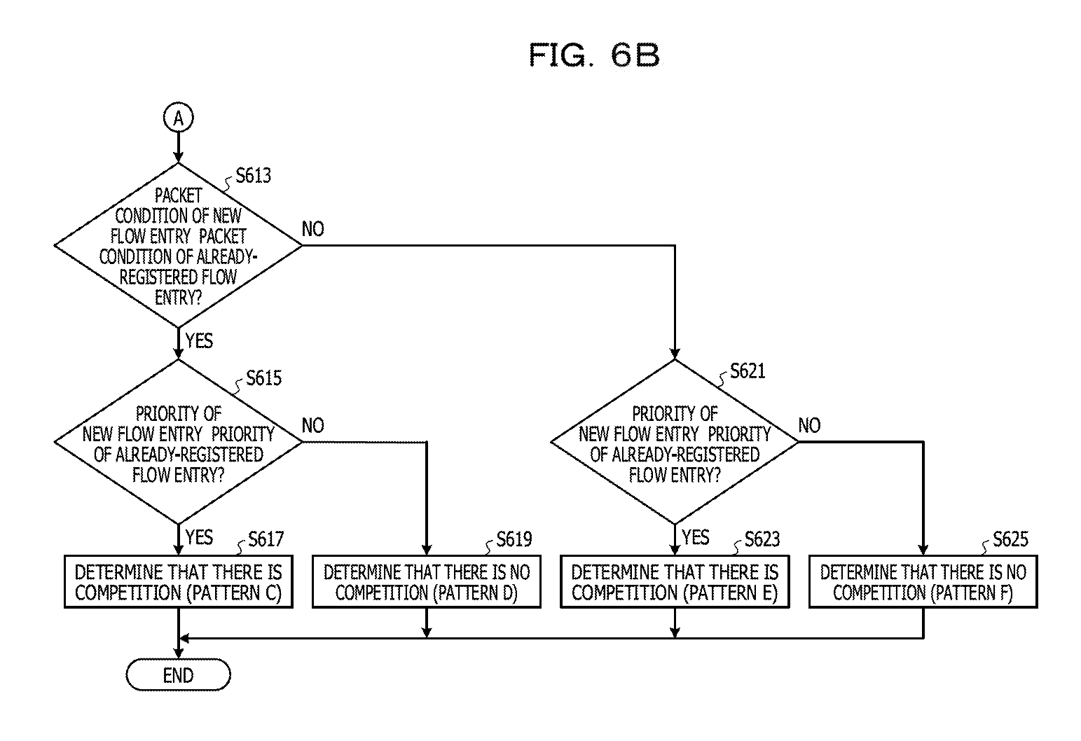

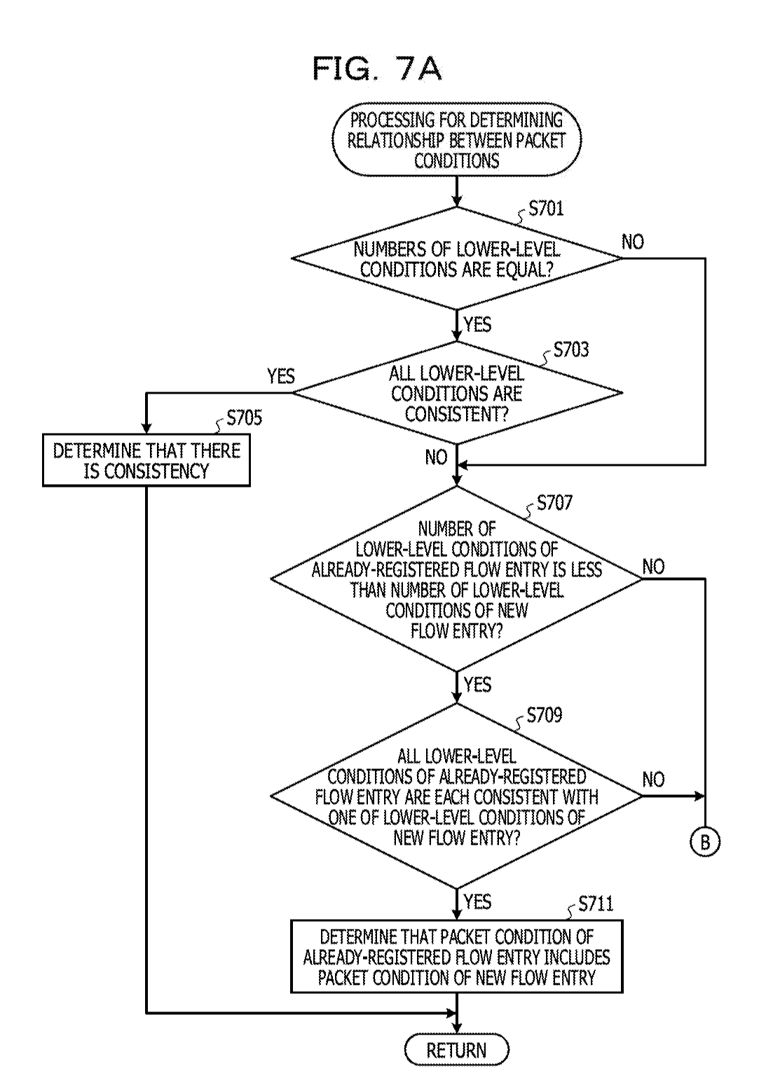

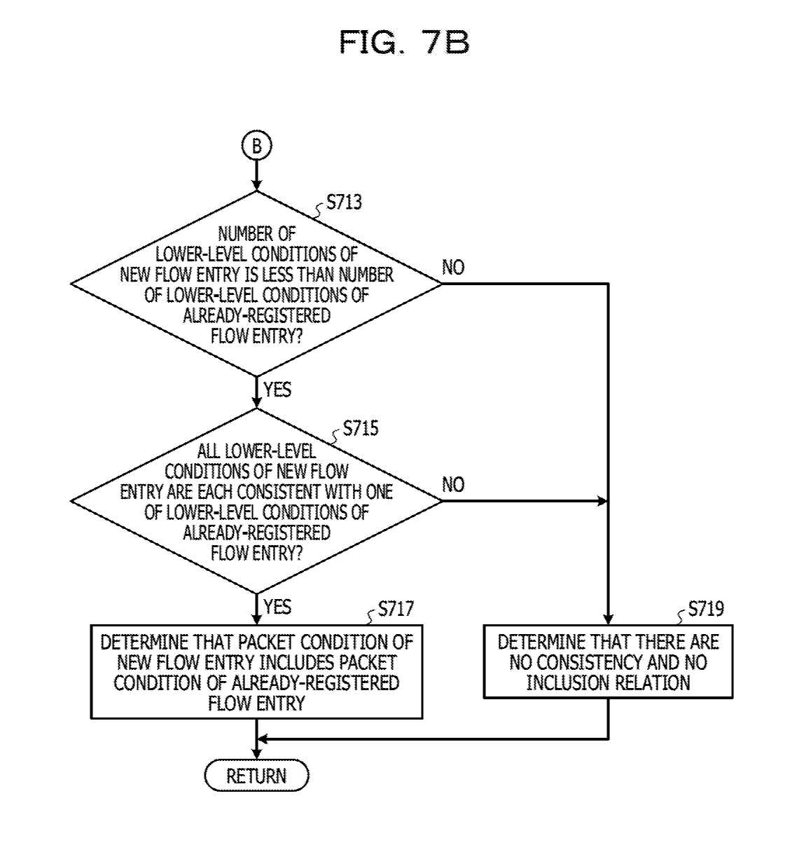

FIG. 6A and FIG. 6B illustrate a detection processing flow in which the determination in FIG. 5 is embodied. First, a determination unit in the SDN controller performs processing for determining a relationship between packet conditions (S601). In the relevant processing, a relationship between a packet condition of a new flow entry and a packet condition of an already-registered flow entry is determined. Details of the relevant processing are illustrated in FIG. 7A and FIG. 7B.

A description shifts to the explanation of FIG. 7A. The determination unit in the SDN controller determines whether or not the number of lower-level conditions in the packet condition of the new flow entry and the number of lower-level conditions in the packet condition of the already-registered flow entry are equal to each other (S701). In a case where it is determined that the numbers of lower-level conditions of the two are equal to each other, the determination unit in the SDN controller determines whether or not all the lower-level conditions in the packet condition of the new flow entry and all the lower-level conditions in the packet condition of the already-registered flow entry are consistent with each other (S703). In a case where all the lower-level conditions of the two are consistent with each other, the determination unit in the SDN controller determines that the packet condition of the new flow entry and the packet condition of the already-registered flow entry are consistent with each other (S705). In addition, the processing for determining a relationship between packet conditions is terminated, and the processing returns to the detection processing serving as a caller.

On the other hand, in a case where, in S701, it is determined that the number of lower-level conditions in the packet condition of the new flow entry and the number of lower-level conditions in the packet condition of the already-registered flow entry are different from each other, the processing shifts to a processing operation in S707. In a case where, in S703, it is determined that at least some of the lower-level conditions in the packet condition of the new flow entry and the lower-level conditions in the packet condition of the already-registered flow entry are inconsistent, the processing shifts to the processing operation in S707.

The determination unit in the SDN controller determines whether or not the number of lower-level conditions in the packet condition of the already-registered flow entry is less than the number of lower-level conditions in the packet condition of the new flow entry (S707). In a case where it is determined that the number of lower-level conditions in the packet condition of the already-registered flow entry is less than the number of lower-level conditions in the packet condition of the new flow entry, the determination unit in the SDN controller determines whether or not all the lower-level conditions in the packet condition of the already-registered flow entry are each consistent with one of the lower-level conditions in the packet condition of the new flow entry (S709). In a case where all the lower-level conditions in the packet condition of the already-registered flow entry are each consistent with one of the lower-level conditions in the packet condition of the new flow entry, the determination unit in the SDN controller determines that the packet condition of the already-registered flow entry includes the packet condition of the new flow entry (S711). In addition, the processing for determining a relationship between packet conditions is terminated, and the processing returns to the detection processing serving as the caller.

On the other hand, in a case where, in S707, it is determined that the number of lower-level conditions in the packet condition of the already-registered flow entry is not less than the number of lower-level conditions in the packet condition of the new flow entry, the processing shifts to a processing operation in S713, illustrated in FIG. 7B, via a terminal B. In a case where, in S709, it is determined that at least some of the lower-level conditions in the packet condition of the already-registered flow entry are each consistent with none of the lower-level conditions in the packet condition of the new flow entry, the processing shifts to the processing operation in S713, illustrated in FIG. 7B, via the terminal B.

A description shifts to the explanation of FIG. 7B. The determination unit in the SDN controller determines whether or not the number of lower-level conditions in the packet condition of the new flow entry is less than the number of lower-level conditions in the packet condition of the already-registered flow entry (S713). In a case where it is determined that the number of lower-level conditions in the packet condition of the new flow entry is less than the number of lower-level conditions in the packet condition of the already-registered flow entry, the determination unit in the SDN controller determines whether or not all the lower-level conditions in the packet condition of the new flow entry are each consistent with one of the lower-level conditions in the packet condition of the already-registered flow entry (S715). In a case where all the lower-level conditions in the packet condition of the new flow entry are each consistent with one of the lower-level conditions in the packet condition of the already-registered flow entry, the determination unit in the SDN controller determines that the packet condition of the new flow entry includes the packet condition of the already-registered flow entry (S717). In addition, the processing for determining a relationship between packet conditions is terminated, and the processing returns to the detection processing serving as the caller.

On the other hand, in a case where, in S713, it is determined that the number of lower-level conditions in the packet condition of the new flow entry is not less than the number of lower-level conditions in the packet condition of the already-registered flow entry, the determination unit in the SDN controller determines that the packet conditions of the two are inconsistent with each other and furthermore there is no inclusion relation therebetween (S719). In a case where, in S715, it is determined that at least some of the lower-level conditions in the packet condition of the new flow entry are each consistent with none of the lower-level conditions in the packet condition of the already-registered flow entry, the determination unit in the SDN controller determines that the packet conditions of the two are inconsistent with each other and furthermore there is no inclusion relation therebetween (S719). In addition, the processing for determining a relationship between packet conditions is terminated, and the processing returns to the detection processing serving as the caller.

A description returns to the explanation of FIG. 6A. Based on whether or not the packet condition of the new flow entry and the packet condition of the already-registered flow entry are consistent with each other or have an inclusion relation therebetween, a detection unit in the SDN controller causes the processing to branch (S603). In a case where the two packet conditions are inconsistent with each other and furthermore there is no inclusion relation therebetween, the detection unit in the SDN controller determines that there is no competition between the new flow entry and the already-registered flow entry (the pattern A) (S605).

On the other hand, in a case where the two packet conditions are consistent with each other or there is an inclusion relation therebetween, the detection unit in the SDN controller determines whether or not a processing content of the new flow entry and a processing content of the already-registered flow entry are inconsistent with each other (S607). In a case where it is determined that the processing content of the new flow entry and the processing content of the already-registered flow entry are not inconsistent with each other, in other words, in a case where the two processing contents are consistent with each other, the detection unit in the SDN controller determines that there is no competition between the new flow entry and the already-registered flow entry (the pattern A) (S605).

In a case where, in S607, it is determined that the processing content of the new flow entry and the processing content of the already-registered flow entry are inconsistent with each other, the detection unit in the SDN controller causes the processing to branch, based on whether or not the packet condition of the new flow entry and the packet condition of the already-registered flow entry are consistent with each other (S609). In a case where the two packet conditions are consistent with each other, the detection unit in the SDN controller determines that the new flow entry and the already-registered flow entry compete with each other (the pattern B) (S611).

On the other hand, in a case where the packet condition of the new flow entry and the packet condition of the already-registered flow entry are inconsistent with each other, the processing shifts to a processing operation in S613, illustrated in FIG. 6B, via a terminal A.

A description shifts to the explanation of FIG. 6B. Based on whether or not there is a relationship in which the packet condition of the already-registered flow entry includes the packet condition of the new flow entry, the detection unit in the SDN controller causes the processing to branch (S613). In a case where there is a relationship in which the packet condition of the already-registered flow entry includes the packet condition of the new flow entry, the detection unit in the SDN controller determines whether or not the priority of the already-registered flow entry is greater than or equal to the priority of the new flow entry (S615). In a case where it is determined that the priority of the already-registered flow entry is greater than or equal to the priority of the new flow entry, the detection unit in the SDN controller determines that the new flow entry and the already-registered flow entry compete with each other (the pattern C) (S617).

In a case where, in S615, it is determined that the priority of the already-registered flow entry is lower than the priority of the new flow entry, the detection unit in the SDN controller determines that there is no competition between the new flow entry and the already-registered flow entry (the pattern D) (S619).

In a case where, in the branching in S613, there is no relationship in which the packet condition of the already-registered flow entry includes the packet condition of the new flow entry, in other words, in a case where there is a relationship in which the packet condition of the new flow entry includes the packet condition of the already-registered flow entry, the detection unit in the SDN controller determines whether or not the priority of the new flow entry is greater than or equal to the priority of the already-registered flow entry (S621). In a case where it is determined that the priority of the new flow entry is greater than or equal to the priority of the already-registered flow entry, the detection unit in the SDN controller determines that the new flow entry and the already-registered flow entry compete with each other (the pattern E) (S623).

In a case where it is determined that the priority of the new flow entry is lower than the priority of the already-registered flow entry, the detection unit in the SDN controller determines that there is no competition between the new flow entry and the already-registered flow entry (the pattern F) (S625).

In the above-mentioned example, in S703 and S709 in FIG. 7A and S715 in FIG. 7B, the number of times the consistency of the lower-level conditions is determined is easy to be increased. In processing for determining the consistency of the lower-level conditions, the number of times a comparison instruction is executed is increased. Therefore, a load on the entire detection processing turns out to be increased.

In, for example, a configuration in which control applications operate, the number of flow entries is increased. The number of lower-level conditions included in packet conditions is increased, compared with the above-mentioned example. As a result, a processing time taken to detect competition is lengthened, and it is difficult to achieve a flexible network operation that is an advantage of the SDN. Therefore, in the present embodiment, a load on processing for detecting competition between flow entries is reduced.

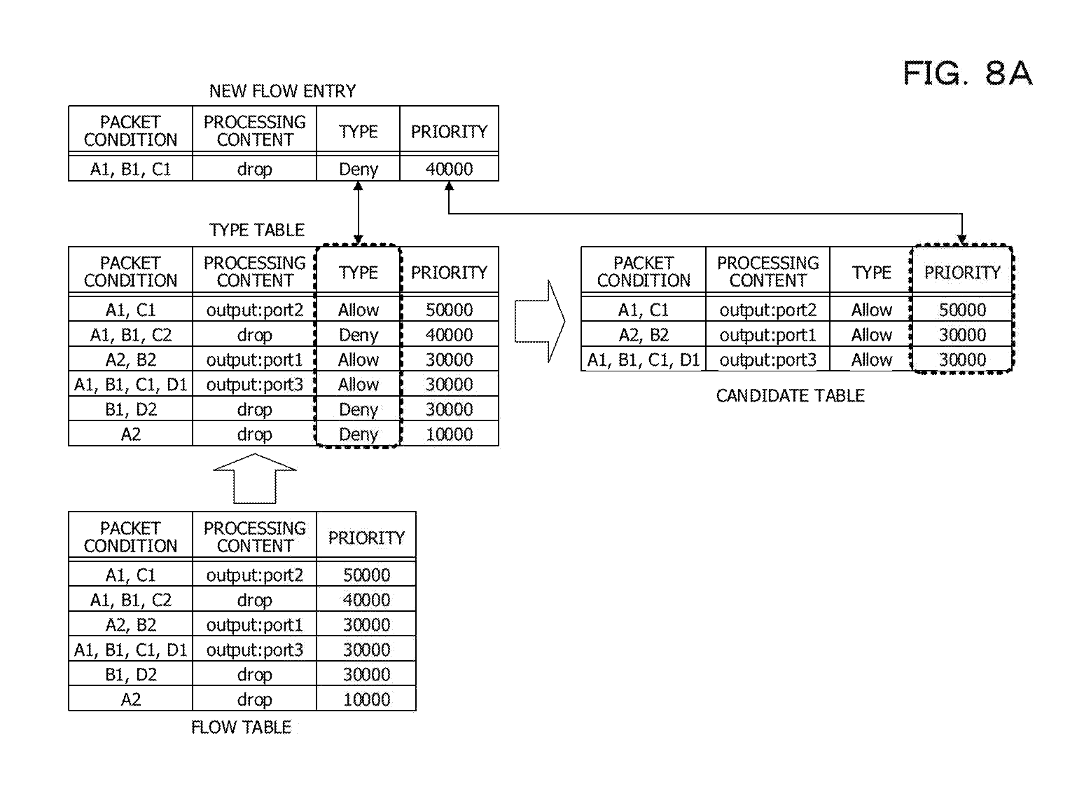

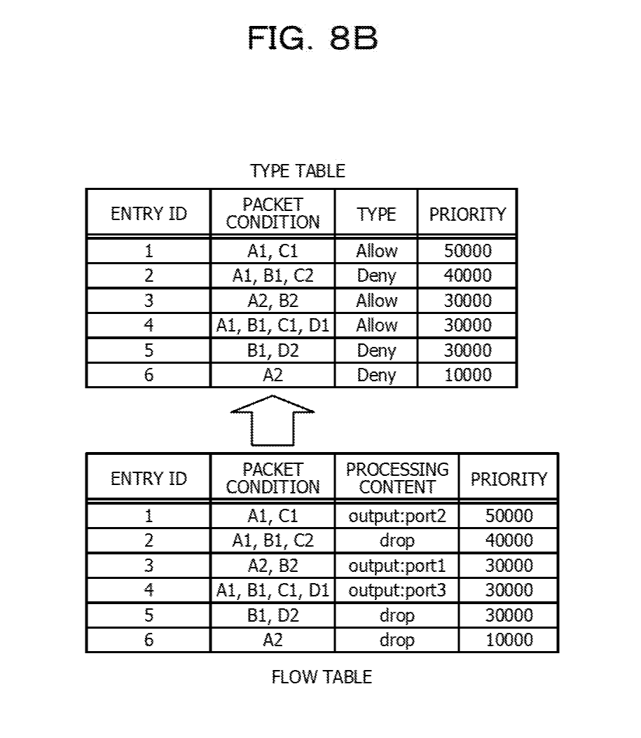

FIG. 8A illustrates examples of respective tables according to the present embodiment. Records of a flow table correspond to already-registered flow entries. In the present embodiment, a type table in which the type of a processing content is assigned to each of the already-registered flow entries is generated before receiving a new flow entry. In this example, processing according to “output” is classified into the type of “Allow” (allow to transfer). The processing of “drop” is classified into the type of “Deny” (deny transfer). In other words, a type in this example is one of the type of “Allow” (allow to transfer) and the type of “Deny” (deny transfer).

In addition, upon receiving the new flow entry, the type of a processing content in the new flow entry is identified in the same way. In addition, an already-registered flow entry corresponding to a type different from the type of the new flow entry is extracted, and the extracted already-registered flow entry is set in a record of a candidate table. The already-registered flow entry set in a record of the candidate table corresponds to a competitive candidate.

Even in a case where a processing content of any one of flow entries according to the same type is executed, the corresponding one of the flow entries turns out to perform the same operation as or an operation closely related to that in a case where a processing content of another one of the flow entries is executed. A case where the processing content is considered to be practically executed in this way is regarded as no competition. By doing so, the number of flow entries to be compared with the new flow entry is reduced.

In addition, based on a result obtained by comparing a priority in the new flow entry with a priority in the already-registered flow entry chosen as the competitive candidate, a determination method that puts a lighter processing load is caused to be selected. Individual determination methods will be described later.

FIG. 8B illustrates other examples. In a type table illustrated in FIG. 8B, processing contents are omitted. In this regard, however, in a case of associating individual records of the type table by using respective entry IDs, it becomes possible to reference records of a flow table.

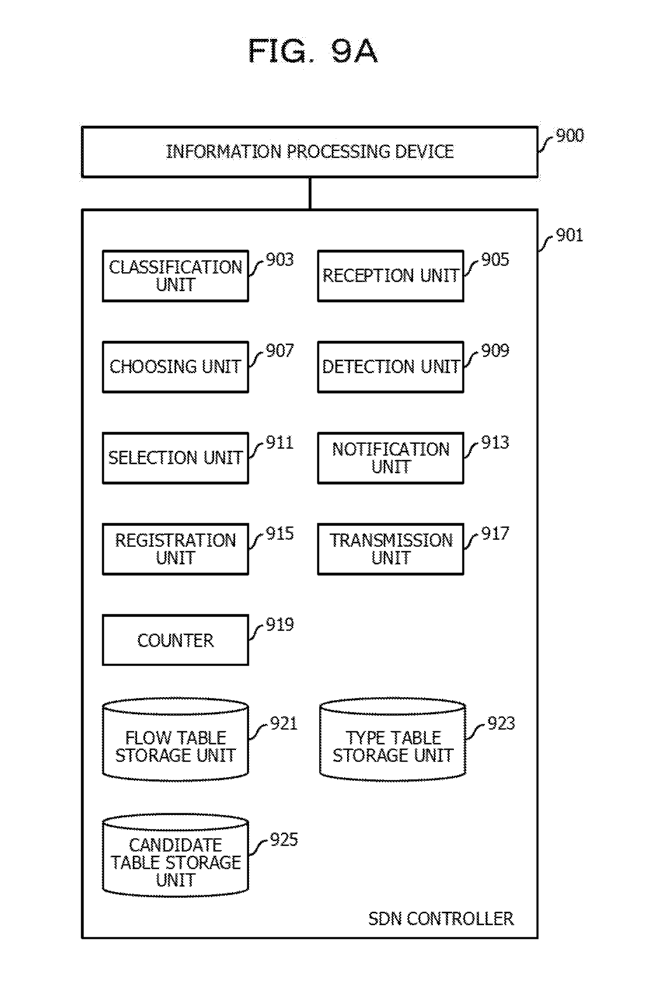

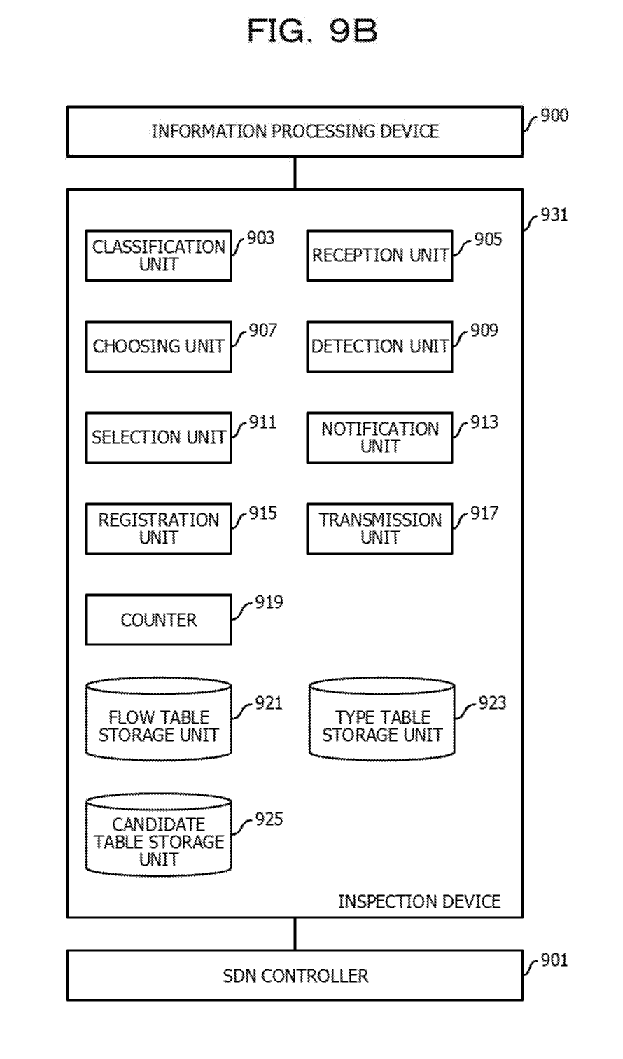

FIG. 9A illustrates an example of a module configuration of an SDN controller 901. An information processing device 900 is coupled to the SDN controller 901. The information processing device 900 and the SDN controller 901 may be coupled to each other via a control network or may be coupled to each other via a network serving as a management target. Alternatively, the coupling may be established via a network different from the control network and the network serving as a management target.

The information processing device 900 is a terminal used by a user serving as a developer of a control application or a network administrator, for example. In this case, based on an operation of the user, the information processing device 900 transmits, to the SDN controller 901, a new flow entry to be registered.

The information processing device 900 may be a server device in which a control application operates, for example. In this case, based on an operation of the control application, the new flow entry is transmitted to the SDN controller 901 by the information processing device 900.

The SDN controller 901 includes a classification unit 903, a reception unit 905, a choosing unit 907, a detection unit 909, a selection unit 911, a notification unit 913, a registration unit 915, a transmission unit 917, a counter 919, a flow table storage unit 921, a type table storage unit 923, and a candidate table storage unit 925.

The classification unit 903 classifies, into predetermined types, processing contents in respective already-registered flow entries. The reception unit 905 receives the new flow entry sent by the information processing device 900. The choosing unit 907 chooses an already-registered flow entry to be compared with the new flow entry, in other words, a competitive candidate. The detection unit 909 detects competition between the new flow entry and the already-registered flow entry. The selection unit 911 selects a determination method in competition detection. The notification unit 913 notifies the information processing device 900 that competition is detected. The registration unit 915 registers the new flow entry in a flow table. The transmission unit 917 transmits the flow table to a communication device to use the relevant flow table. The counter 919 calculates the number of lower-level conditions included in a packet condition.

The flow table storage unit 921 stores therein the flow table. The type table storage unit 923 stores therein a type table. The candidate table storage unit 925 stores therein a candidate table.

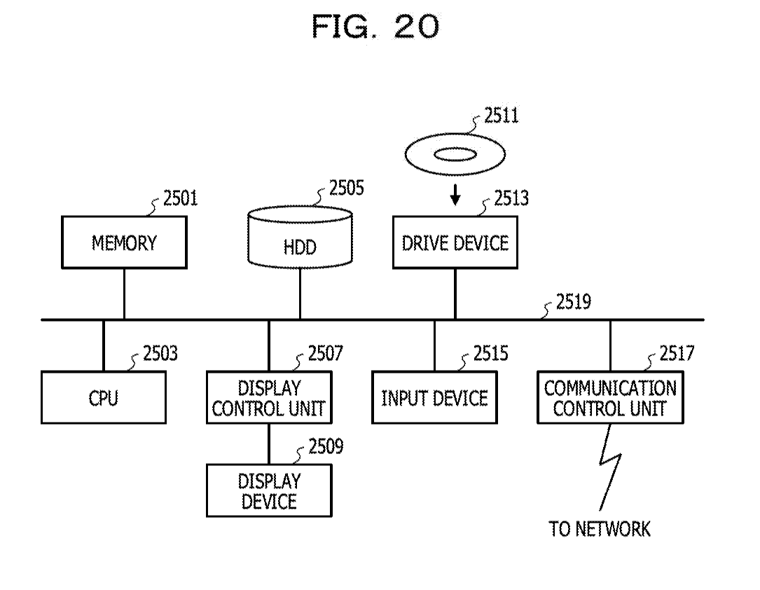

The classification unit 903, the reception unit 905, the choosing unit 907, the detection unit 909, the selection unit 911, the notification unit 913, the registration unit 915, the transmission unit 917, and the counter 919, described above, are realized by using hardware resources (in, for example, FIG. 20) and a program that causes a processor to perform processing described below.

The flow table storage unit 921, the type table storage unit 923, and the candidate table storage unit 925, described above, are realized by using the hardware resources (in, for example, FIG. 20).

In the example of FIG. 9A, in the SDN controller 901, the presence or absence of competition is inspected. In this regard, however, an inspection device may be installed separately from the SDN controller 901. FIG. 9B illustrates an example of a module configuration of an inspection device 931.

The inspection device 931 is coupled to the above-mentioned information processing device 900. The information processing device 900 and the inspection device 931 may be coupled to each other via a control network or may be coupled to each other via a network serving as a management target. Alternatively, the coupling may be established via a network different from the control network and the network serving as a management target.

The inspection device 931 is coupled to the SDN controller 901. The inspection device 931 and the SDN controller 901 may be coupled to each other via a control network or may be coupled to each other via a network serving as a management target. Alternatively, the coupling may be established via a network different from the control network and the network serving as a management target.

The inspection device 931 includes the same modules as the respective modules of the SDN controller 901 illustrated in FIG. 9A. In a case of FIG. 9B, the transmission unit 917 in the inspection device 931 transmits no flow table. As alternated, the transmission unit 917 in the inspection device 931 transfers a new flow entry to the SDN controller 901. In addition, the SDN controller 901 operates in the same way as in the related art. The inspection device 931 may transfer, to the SDN controller 901, only a new flow entry that does not compete, for example.

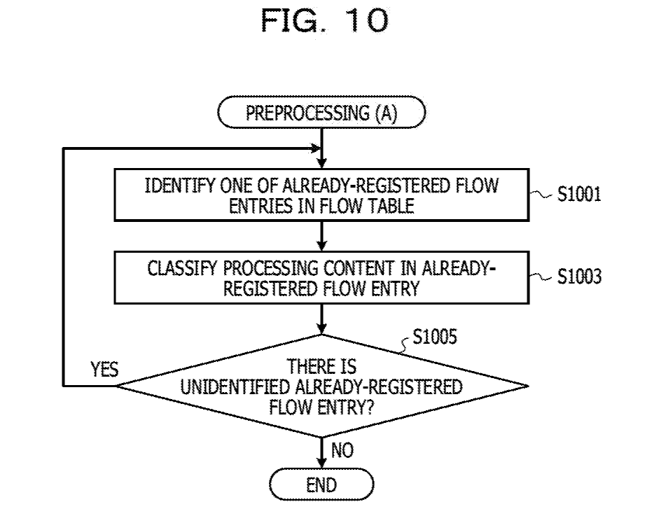

As described above, before receiving the new flow entry from the information processing device 900, the SDN controller 901 performs preprocessing for assigning types to respective already-registered flow entries. FIG. 10 illustrates a preprocessing (A) flow. The classification unit 903 identifies one of already-registered flow entries in the flow table (S1001). In this regard, however, an already-registered flow entry to which a type is already assigned may be excluded from identification targets.

The classification unit 903 classifies a processing content in the identified already-registered flow entry (S1003). In this example, processing according to “output” is classified into the type of “Allow” (allow to transfer). The processing of “drop” is classified into the type of “Deny” (deny transfer). The classification result is set in a record of the type table. In items other than that of an type in the record of the type table, the same contents as those of a corresponding one of flow entries of the flow table are set.

The classification unit 903 determines whether or not there is an unidentified already-registered flow entry in the flow table (S1005). In a case where it is determined that there is an unidentified already-registered flow entry, the processing returns to the processing operation illustrated in S1001, and the above-mentioned processing is repeated. On the other hand, in a case where it is determined that there is no unidentified already-registered flow entry, the preprocessing (A) is terminated.

Upon terminating the preprocessing (A), a preparation for receiving a new flow entry is completed. A main processing (A) illustrated below is processing performed in response to reception of the new flow entry.

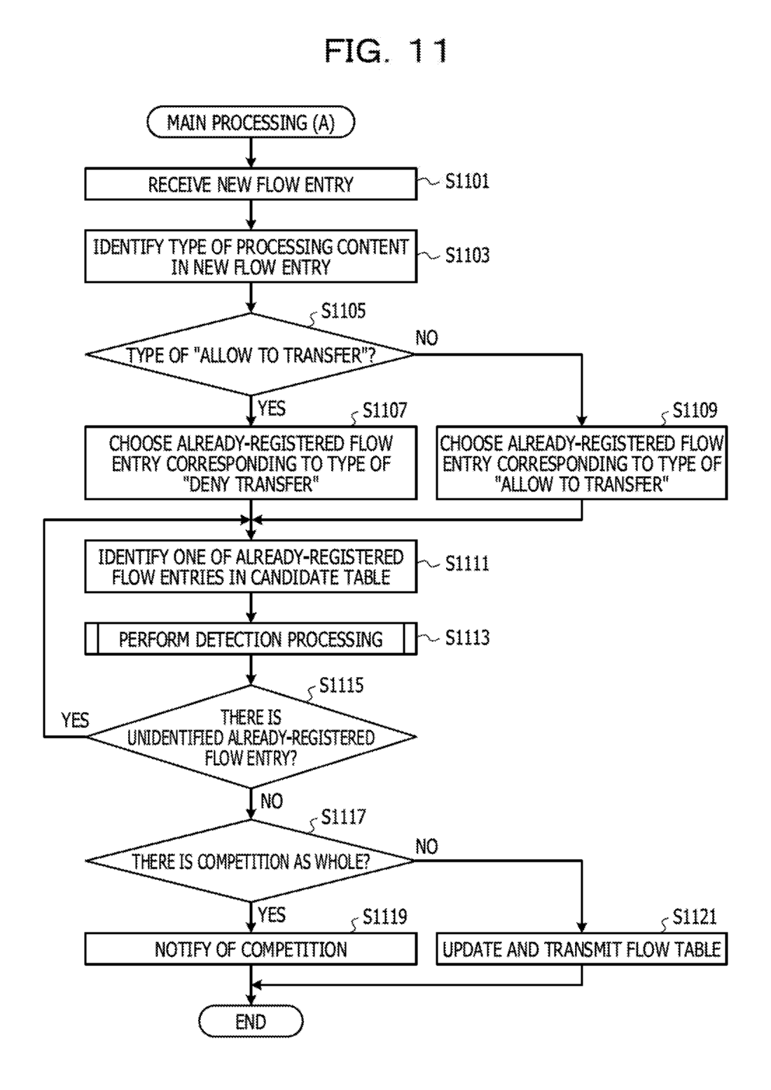

FIG. 11 illustrates the main processing (A). In a case where the reception unit 905 receives a new flow entry (S1101), the choosing unit 907 identifies the type of a processing content in the relevant new flow entry (S1103). At this time, the choosing unit 907 classifies the processing content in the same way as in a case of the processing operation in S1003 illustrated in FIG. 10.

The choosing unit 907 determines whether or not the type identified in S1103 is “Allow” (allow to transfer) (S1105). In addition, in a case where it is determined that the identified type is “Allow” (allow to transfer), the choosing unit 907 chooses, from records of the type table, an already-registered flow entry corresponding to the type of “Deny” (deny transfer) (S1107). The chosen already-registered flow entry is set in the candidate table. In other words, a record corresponding to the type of “Deny” (deny transfer) is extracted from the type table, and the extracted record is copied to the candidate table.

On the other hand, in a case where it is determined that the identified type is not “Allow” (allow to transfer), in other words, in a case where the identified type is “Deny” (deny transfer), the choosing unit 907 chooses, from records of the type table, an already-registered flow entry corresponding to the type of “Allow” (allow to transfer) (S1109). The chosen already-registered flow entry is set in the candidate table. In other words, a record corresponding to the type of “Allow” (allow to transfer) is extracted from the type table, and the extracted record is copied to the candidate table.

In a case where the candidate table is generated, the detection unit 909 identifies one of already-registered flow entries in the candidate table (S1111). The detection unit 909 identifies a record of the candidate table in order, for example.

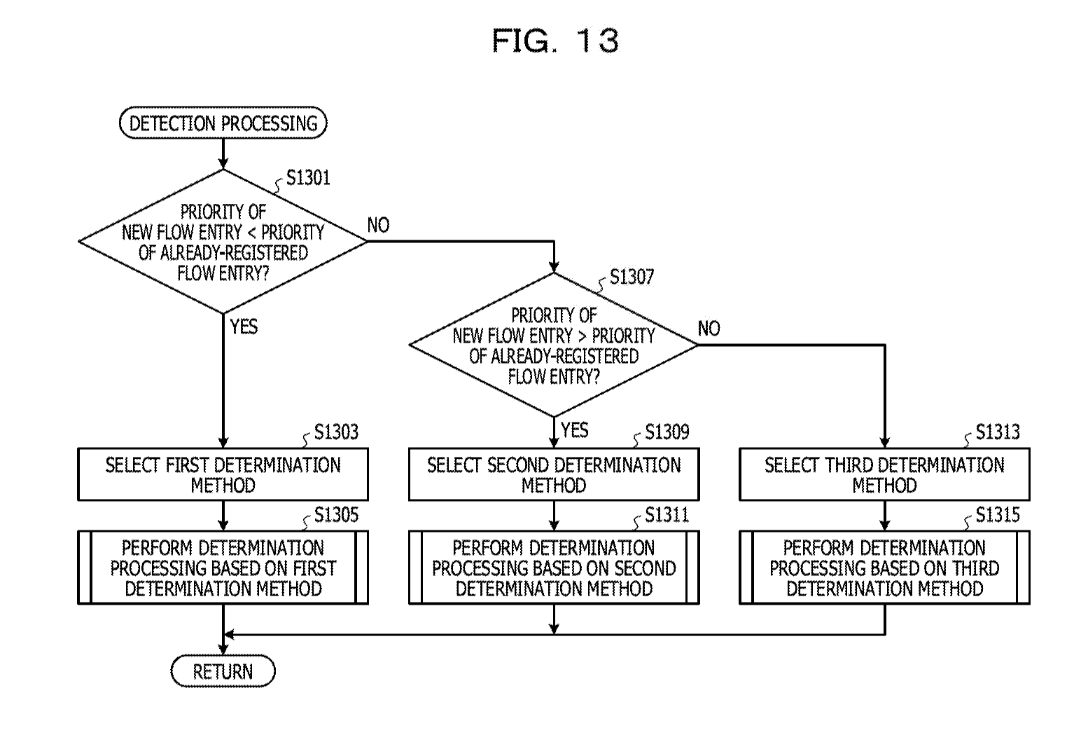

The detection unit 909 performs detection processing related to the identified already-registered flow entry (S1113). In the detection processing, competition between the new flow entry and the relevant already-registered flow entry is detected. In other words, as a result of the detection processing, the presence or absence of competition becomes clear. The detection processing will be described later by using FIG. 13 and so forth. A result of the detection processing related to each of already-registered flow entries is held up until a processing operation in S1117 in this example.

The detection unit 909 determines whether or not there is an unidentified already-registered flow entry in the candidate table (S1115). In a case where it is determined that there is an unidentified already-registered flow entry, the processing returns to the processing operation illustrated in S1111, and the above-mentioned processing is repeated. On the other hand, in a case where it is determined that there is no unidentified already-registered flow entry, the detection unit 909 determines whether or not there is competition as a whole (S1117). In a case where it is determined that there is competition in at least one of results of the detection processing related to individual already-registered flow entries, it is determined that there is competition as a whole. On the other hand, in a case where there is no competition in results of the detection processing related to the individual already-registered flow entries, it is determined that there is no competition as a whole.

In a case where it is determined that there is competition as a whole, the notification unit 913 notifies the information processing device 900 that competition is detected (S1119).

On the other hand, in a case where it is determined that there is no competition as a whole, the registration unit 915 updates the flow table. In other words, the new flow entry is added to the flow table. In addition, the transmission unit 917 transmits the updated flow table to a communication device to use the relevant flow table (S1121). In addition, the main processing (A) is terminated once.

In a case where the new flow entry is added to the flow table, a type related to the relevant flow entry type is identified in the subsequently activated preprocessing (A), and a record including the relevant type is added to the type table.

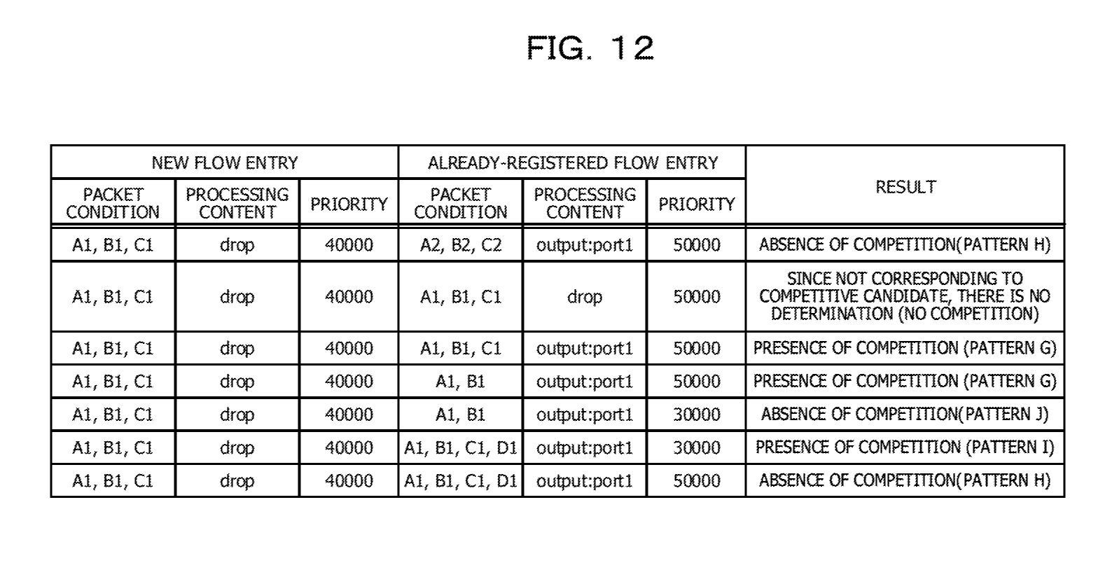

FIG. 12 illustrates determination patterns of competition in the present embodiment. Combinations of a new flow entry and already-registered flow entries in respective records are the same as those in a case of FIG. 5.

Since, in S1109 in FIG. 11, not being chosen as a competitive candidate, a combination corresponding to the second record does not become a target of the detection processing in and after S1111. Combinations corresponding to the other records will be described later.

FIG. 13 illustrates a detection processing flow in the present embodiment. First, the selection unit 911 determines whether or not the priority of an already-registered flow entry is higher than the priority of a new flow entry (S1301).

In a case where it is determined that the priority of the already-registered flow entry is higher than the priority of the new flow entry, the selection unit 911 selects a first determination method (S1303). In addition, the notification unit 913 performs determination processing based on the first determination method (S1305).

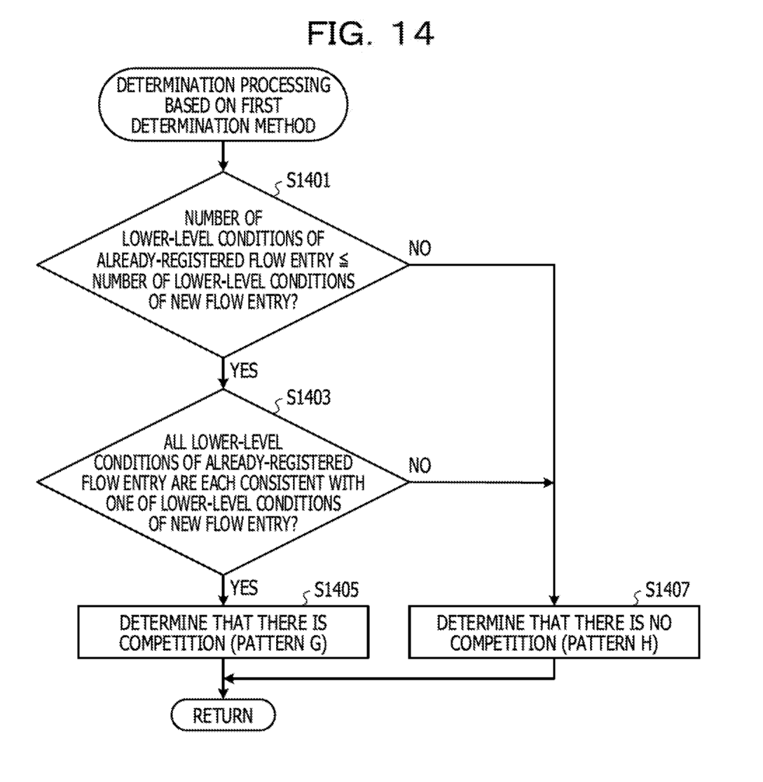

FIG. 14 illustrates a determination processing flow based on the first determination method. The notification unit 913 determines whether or not the number of lower-level conditions of the new flow entry is greater than or equal to the number of lower-level conditions of the already-registered flow entry (S1401). In a case where it is determined that the number of lower-level conditions of the new flow entry is greater than or equal to the number of lower-level conditions of the already-registered flow entry, the notification unit 913 determines whether or not all the lower-level conditions of the already-registered flow entry are each consistent with one of the lower-level conditions of the new flow entry (S1403). In addition, in a case where it is determined that all the lower-level conditions of the already-registered flow entry are each consistent with one of the lower-level conditions of the new flow entry, the notification unit 913 determines that the two compete with each other (a pattern G) (S1405). The combination of flow entries in the third record and the combination of flow entries in the fourth record, illustrated in FIG. 12, each correspond to this determination pattern.

On the other hand, in a case where, in S1401, it is determined that the number of lower-level conditions of the new flow entry is less than the number of lower-level conditions of the already-registered flow entry, the notification unit 913 determines that the two do not compete with each other (a pattern H) (S1407). The combination of flow entries in the seventh record illustrated in FIG. 12 corresponds to this determination pattern.

In a case where, in S1403, it is determined that one of the lower-level conditions of the already-registered flow entry is consistent with none of the lower-level conditions of the new flow entry, the notification unit 913 determines that the two do not compete with each other (the pattern H) (S1407). The combination of flow entries in the first record illustrated in FIG. 12 corresponds to this determination pattern.

In a case where the determination processing based on the first determination method finishes, the processing returns to the detection processing serving as a caller.

A description returns to the explanation of FIG. 13. In a case where the determination processing based on the first determination method and illustrated in S1305 finishes, the detection processing finishes.

A description returns to the explanation of S1301. In a case where, in S1301, it is determined that the priority of the already-registered flow entry is not higher than the priority of the new flow entry, the selection unit 911 determines whether or not the priority of the new flow entry is higher than the priority of the already-registered flow entry (S1307). In a case where it is determined that the priority of the new flow entry is higher, the selection unit 911 selects a second determination method (S1309). In addition, the notification unit 913 performs determination processing based on the second determination method (S1311).

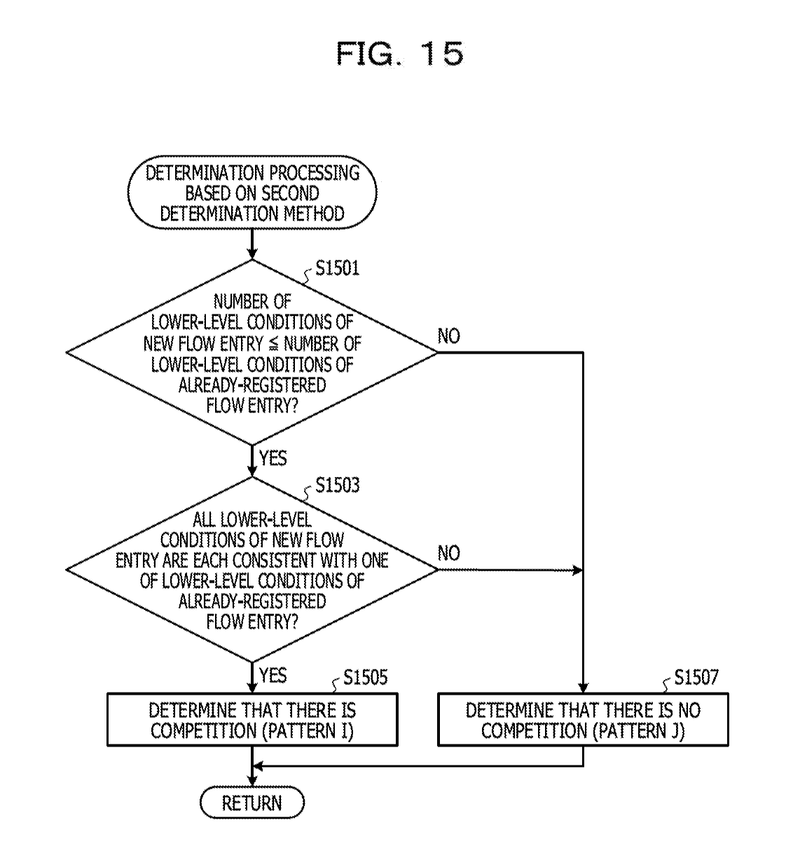

FIG. 15 illustrates a determination processing flow based on the second determination method. The notification unit 913 determines whether or not the number of lower-level conditions of the already-registered flow entry is greater than or equal to the number of lower-level conditions of the new flow entry (S1501). In a case where it is determined that the number of lower-level conditions of the already-registered flow entry is greater than or equal to the number of lower-level conditions of the new flow entry, the notification unit 913 determines whether or not all the lower-level conditions of the new flow entry are each consistent with one of the lower-level conditions of the already-registered flow entry (S1503). In addition, in a case where it is determined that all the lower-level conditions of the new flow entry are each consistent with one of the lower-level conditions of the already-registered flow entry, the notification unit 913 determines that the two compete with each other (a pattern I) (S1505). The combination of flow entries in the sixth record illustrated in FIG. 12 corresponds to this determination pattern.

On the other hand, in a case where, in S1501, it is determined that the number of lower-level conditions of the already-registered flow entry is less than the number of lower-level conditions of the new flow entry, the notification unit 913 determines that the two do not compete with each other (a pattern J) (S1507). The combination of flow entries in the fifth record illustrated in FIG. 12 corresponds to this determination pattern.

In a case where, in S1503, it is determined that one of the lower-level conditions of the new flow entry is consistent with none of the lower-level conditions of the already-registered flow entry, the notification unit 913 determines that the two do not compete with each other (the pattern J) (S1507). An example of this determination pattern is not illustrated in FIG. 12.

In a case where the determination processing based on the second determination method finishes, the processing returns to the detection processing serving as the caller.

A description returns to the explanation of FIG. 13. In a case where the determination processing based on the second determination method and illustrated in S1311 finishes, the detection processing finishes.

A description returns to the explanation of S1307. In a case where, in S1307, it is determined that the priority of the new flow entry is not higher than the priority of the already-registered flow entry, in other words, the priorities of the two flow entries are equal to each other, the selection unit 911 selects a third determination method (S1313). In addition, the notification unit 913 performs determination processing based on the third determination method (S1315).

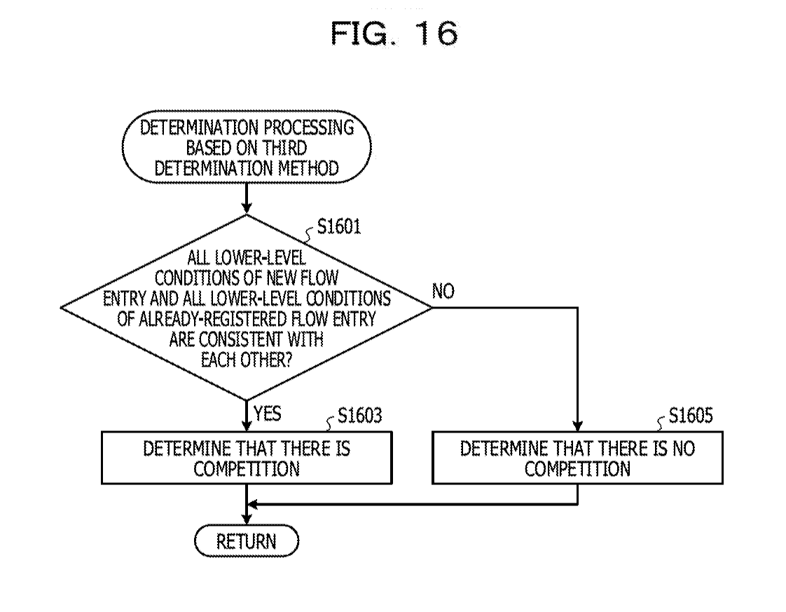

FIG. 16 illustrates a determination processing flow based on the third determination method. The notification unit 913 determines whether or not all the lower-level conditions of the new flow entry and all the lower-level conditions of the already-registered flow entry are consistent with each other (S1601). In a case where it is determined that all the lower-level conditions of the new flow entry and all the lower-level conditions of the already-registered flow entry are consistent with each other, the notification unit 913 determines that the two compete with each other (S1603). An example of this determination pattern is not illustrated in FIG. 12.

On the other hand, in a case where it is determined that at least some of the lower-level conditions of the new flow entry and the lower-level conditions of the already-registered flow entry are inconsistent, the notification unit 913 determines that the two do not compete with each other (S1605). An example of this determination pattern is not illustrated in FIG. 12.

In a case where the determination processing based on the third determination method finishes, the processing returns to the detection processing serving as the caller.

A description returns to the explanation of FIG. 13. In a case where the determination processing based on the third determination method and illustrated in S1315 finishes, the detection processing finishes. In a case where the detection processing finishes, the processing returns to the main processing (A) serving as the caller.

According to the present embodiment, it is possible to reduce a load on processing for detecting competition associated with addition of a flow entry.

According to the present embodiment, a processing content is classified into the type of “allow to transfer” or the type of “deny transfer”. Therefore, it is possible to foresee a problem in packet transfer, caused by competition between flow entries.

According to the present embodiment, the number of already-registered flow entries to serve as targets for comparisons with a new flow entry is reduced. Therefore, a processing load on detection of competition is reduced.

According to the present embodiment, a relatively small amount of determination processing related to an inclusion relation between packet conditions is taken. Therefore, a processing load is reduced as a whole.

### Second Embodiment

In the above-mentioned embodiment, an example in which flow entries to serve as competitive candidates are chosen, based on types, from already-registered flow entries is described. In the present embodiment, an example in which already-registered flow entries to serve as competitive candidates are further narrowed down based on the number of lower-level conditions and priorities.

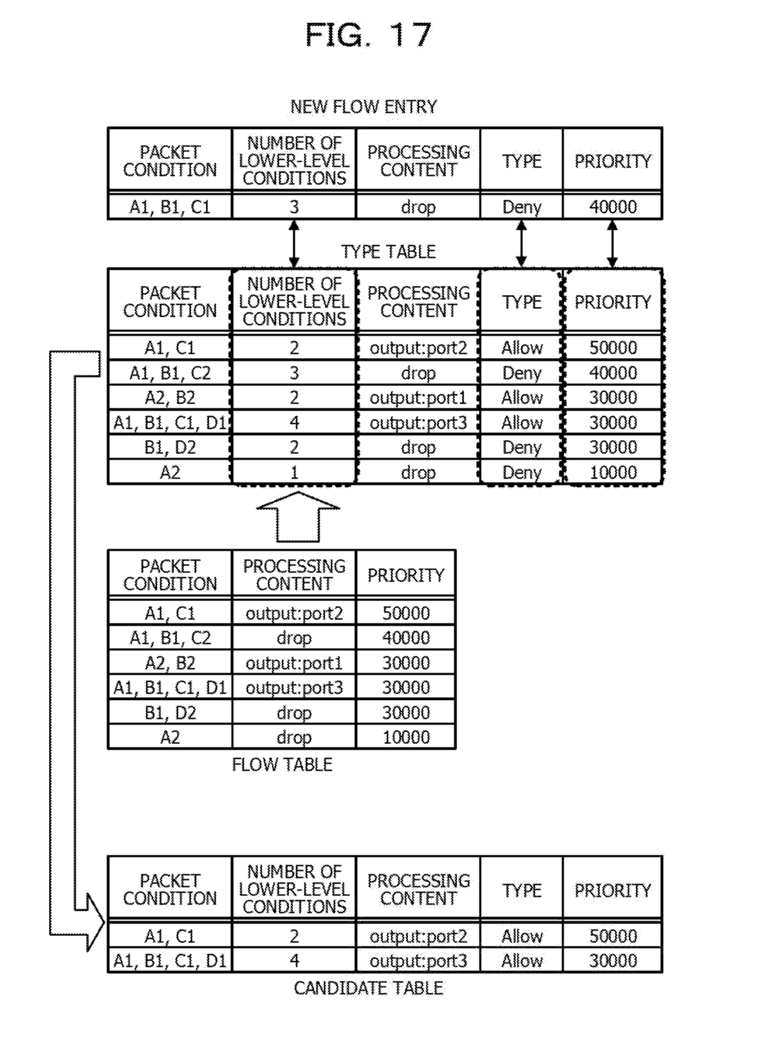

FIG. 17 illustrates examples of respective tables in the second embodiment. In the second embodiment, regarding each of already-registered flow entries, the number of lower-level conditions included in the packet condition of the relevant already-registered flow entry is counted in advance in the preprocessing. In addition, the number of lower-level conditions is set in a record of a type table.

Upon receiving a new flow entry, the number of lower-level conditions included in the packet condition of the new flow entry is counted. In addition, based on a result of a comparison between priorities and a result of a comparison between the numbers of lower-level conditions, already-registered flow entries to serve as competitive candidates are narrowed down.

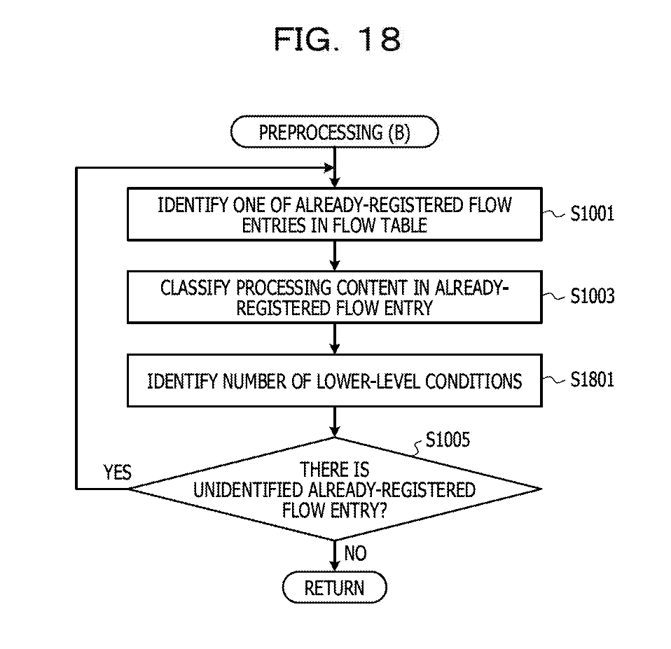

In the second embodiment, preprocessing (B) is performed in place of the preprocessing (A). FIG. 18 illustrates a preprocessing (B) flow. Processing operations illustrated in S1001 and S1003 are the same as those in a case of FIG. 10.

The counter 919 identifies the number of lower-level conditions included in the packet condition of the already-registered flow entry identified in S1001 (S1801). The number of lower-level conditions is set in a record of the type table. A processing operation illustrated in S1005 is the same as that in a case of FIG. 10.

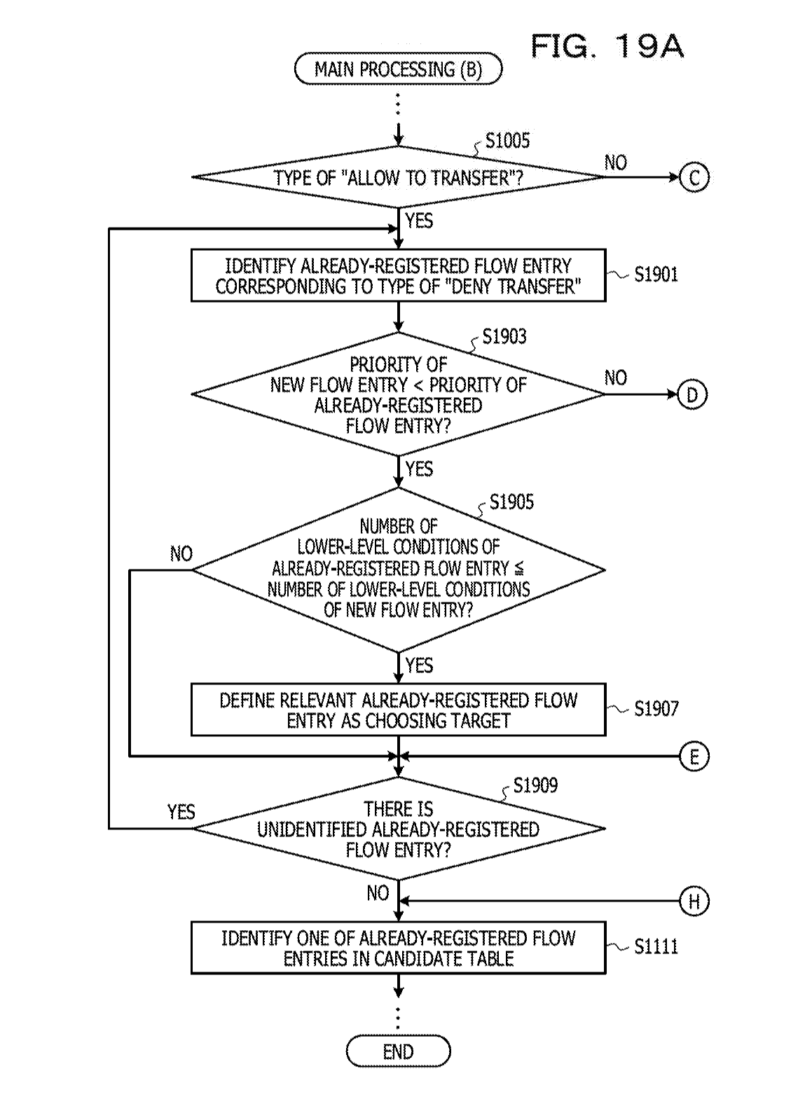

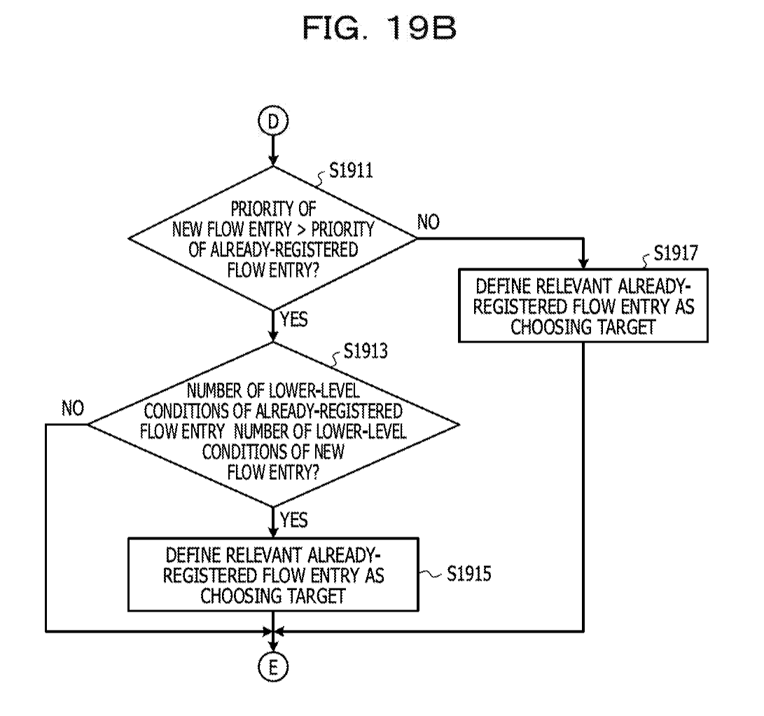

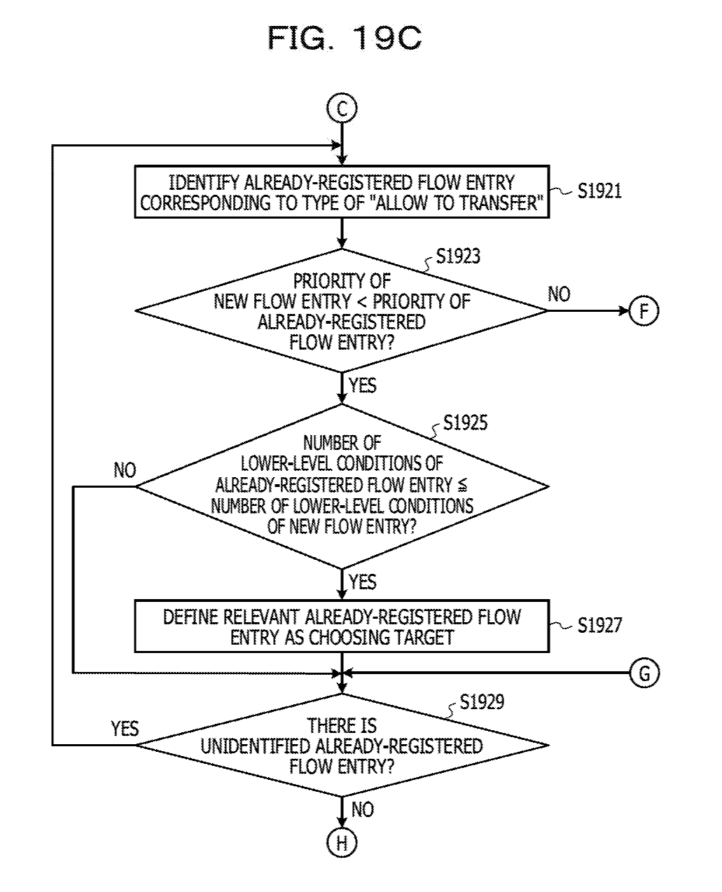

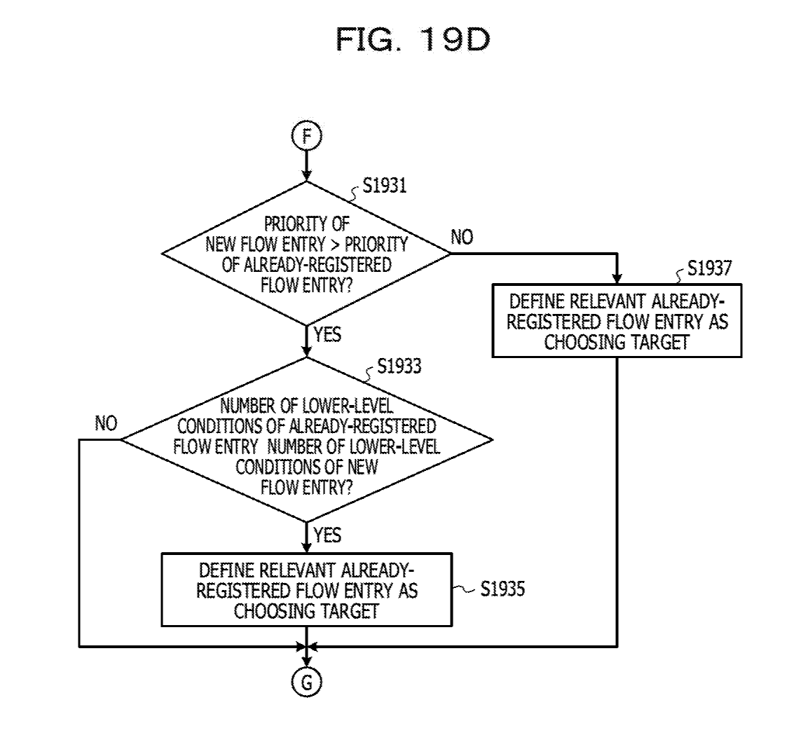

In the second embodiment, main processing (B) is performed in place of the main processing (A). FIG. 19A illustrates a main processing (B) flow. In the same way as in a case of FIG. 11, the processing operations illustrated in S1101 to S1105 in FIG. 11 are performed.

In a case where, in S1105, it is determined that the type identified in S1103 is “Allow” (allow to transfer), the choosing unit 907 identifies, from records of the type table, an already-registered flow entry corresponding to the type of “Deny” (deny transfer) (S1901). In the type table, the detection unit 909 identifies, in accordance with an order, a record for which “Deny” (deny transfer) is set in the field of a type, for example.

The choosing unit 907 determines whether or not the priority of the identified already-registered flow entry is higher than the priority of the new flow entry (S1903). In a case where it is determined that the priority of the already-registered flow entry is higher, the choosing unit 907 further determines whether or not the number of lower-level conditions of the already-registered flow entry is less than or equal to the number of lower-level conditions of the new flow entry (S1905).

In a case where the priority of the already-registered flow entry is higher and the number of lower-level conditions of the already-registered flow entry is not greater, there is a possibility that the relevant already-registered flow entry competes with the new flow entry. Accordingly, the choosing unit 907 defines the relevant already-registered flow entry as a choosing target (S1907). The chosen already-registered flow entry is set in a candidate table.

On the other hand, if the number of lower-level conditions of the already-registered flow entry is greater in a case where the priority of the already-registered flow entry is higher, there is no possibility that the relevant already-registered flow entry competes with the new flow entry. Accordingly, the choosing unit 907 does not define the relevant already-registered flow entry as a choosing target.

In addition, in S1909, the choosing unit 907 determines whether or not an already-registered flow entry that corresponds to the type of “Deny” (deny transfer) and that is unidentified exists in the type table. In a case where it is determined the unidentified already-registered flow entry exists, the processing returns to the processing operation illustrated in S1901, and the above-mentioned processing is repeated.

On the other hand, in a case where it is determined no unidentified already-registered flow entry exists, the processing shifts to the processing operation in S1111. Processing operations in and after S1111 are the same as those in a case of FIG. 11.

A description returns to the explanation of S1903. In a case where, in S1903, it is determined that the priority of the already-registered flow entry is not higher than the priority of the new flow entry, the processing shifts, via a terminal D, to a processing operation in S1911 illustrated in FIG. 19B.

A description shifts to the explanation of FIG. 19B. The choosing unit 907 determines whether or not the priority of the new flow entry is higher than the priority of the already-registered flow entry identified in S1901 in FIG. 19A (S1911). In a case where it is determined that the priority of the new flow entry is higher, the choosing unit 907 determines whether or not the number of lower-level conditions of the new flow entry is less than or equal to the number of lower-level conditions of the already-registered flow entry (S1913).

In a case where the priority of the new flow entry is higher and the number of lower-level conditions of the new flow entry is not greater, there is a possibility that the already-registered flow entry competes with the new flow entry. Accordingly, the choosing unit 907 defines the relevant already-registered flow entry as a choosing target (S1915). The chosen already-registered flow entry is set in the candidate table.

On the other hand, if the number of lower-level conditions of the new flow entry is greater in a case where the priority of the new flow entry is higher, there is no possibility that the already-registered flow entry competes with the new flow entry. Accordingly, the choosing unit 907 does not define the relevant already-registered flow entry as a choosing target.

In a case where, in S1911, it is determined that the priority of the new flow entry is not higher, in other words, in a case where the priority of the new flow entry and the priority of the already-registered flow entry are equal to each other, there is a possibility that the already-registered flow entry competes with the new flow entry. Accordingly, the choosing unit 907 defines the relevant already-registered flow entry as a choosing target (S1917).

In addition, the processing returns, via a terminal E, to the processing operation in S1909 illustrated in FIG. 19A.

A description returns to the explanation of FIG. 19A. In a case where, S1105, it is determined that the type identified in S1103 is not “Allow” (allow to transfer), in other words, in a case where the identified type is “Deny” (deny transfer), the processing shifts, via a terminal C, to a processing operation in S1921 illustrated in FIG. 19C.

A description shifts to the explanation of FIG. 19C. The choosing unit 907 identifies, from within records of the type table, an already-registered flow entry corresponding to the type of “Allow” (allow to transfer) (S1921). In the type table, the detection unit 909 identifies, in accordance with an order, a record for which “Allow” (allow to transfer) is set in the field of a type, for example.

Processing operations illustrated in S1923 to S1929 are the same as the processing operations in S1903 to S1909 illustrated in FIG. 19A.

In a case where, in S1923, it is determined that the priority of the already-registered flow entry is not higher than the priority of the new flow entry, the processing shifts, via a terminal F, to a processing operation in S1931 illustrated in FIG. 19D.

Processing operations illustrated in S1931 to S1937 illustrated in FIG. 19D are the same as the processing operations in S1911 to S1917 illustrated in FIG. 19B. In a case where the processing illustrated in FIG. 19D finishes, the processing shifts, via a terminal G, to a processing operation in S1929 illustrated in FIG. 19C. In a case where, in the processing operation in S1923, it is determined that no specific already-registered flow entry exists, the processing shifts, via a terminal H, to the processing operation in S1111 illustrated in FIG. 19A. The processing operations in and after S1111 are the same as those in a case of FIG. 11. This is the end of the explanation of the main processing (B).

According to the present embodiment, the number of already-registered flow entries to serve as targets for comparisons with a new flow entry is reduced. Therefore, a processing load on detection of competition is further reduced.

### Third Embodiment

In the above-mentioned embodiment, an example in which, in the main processing, already-registered flow entries according to a different type are chosen as competitive candidates is described.

In this regard, however, in the preprocessing, a table for each of types may be provided. In other words, a table in which only already-registered flow entries corresponding to the type of “Allow” (allow to transfer) are collected and a table in which only already-registered flow entries corresponding to the type of “Deny” (deny transfer) are collected may be generated.

In addition, in the main processing, a table according to a type different from the type of a processing content in a new flow entry may be chosen.

While, as above, embodiments of the present technology are described, the present technology is not limited to these. The above-mentioned functional block configuration is inconsistent with a program module configuration in some cases, for example.

A configuration of each of the storage areas described above is an example, and such a configuration as described above does not have to be adopted. Furthermore, in a processing flow, as long as a processing result is not changed, the order of processing operations may be changed or processing operations may be performed in parallel.

Each of the SDN controller 901 and the inspection device 931 described above is a computer device. As illustrated in FIG. 20, a memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 used for coupling to a network are coupled by a bus 2519. An operating system (OS) and an application program for implementing processing operations in the present embodiment are stored in the HDD 2505. In addition, in a case of being executed by the CPU 2503, the operating system and the application program are read from the HDD 2505 to the memory 2501. In accordance with processing contents of the application program, the CPU 2503 controls the display control unit 2507, the communication control unit 2517, and the drive device 2513, thereby causing predetermined operations to be performed. While being mainly stored in the memory 2501, data in processing may be stored in the HDD 2505. In examples of the present technology, the application program for implementing processing operations described above is stored in the computer-readable removable disk 2511 and is distributed, thereby being installed from the drive device 2513 into the HDD 2505. In some cases, the application program is installed into the HDD 2505 via a network such as the Internet and the communication control unit 2517. Pieces of hardware such as the CPU 2503 and the memory 2501 and programs such as the OS and the application program organically work together with one another. Accordingly, such a computer device realizes such various kinds of functions as described above.

Embodiments of the present technology, described above, are summarized as follows.

An information processing device according to the present embodiment is an information processing device to store therein flow entries in each of which a condition for identifying a flow and a processing content corresponding to a packet of the relevant flow are associated with each other, the information processing device including (A) a choosing unit that chooses, from the stored flow entries, competitive candidates corresponding to a new flow entry, based on a type of a processing content of the new flow entry and types of processing contents of the stored flow entries, in a case of newly storing the new flow entry, and (B) a detection unit that detects, from within flow entries chosen as the competitive candidates, a flow entry to compete with the new flow entry.

By doing so, it is possible to reduce a load on processing for detecting competition associated with addition of a flow entry.

Furthermore, the above-mentioned types may include the type of “allow to transfer” and the type of “deny transfer”.

By doing so, it is possible to foresee a problem in packet transfer, caused by competition between flow entries.

Furthermore, the above-mentioned choosing unit may choose a competitive candidate under a choosing condition of not corresponding to the above-mentioned type of the new flow entry.

By doing so, the number of targets for comparisons with the new flow entry is reduced. Therefore, a processing load on detection of competition is reduced.

Furthermore, in each of the flow entries, a priority may be associated with the above-mentioned condition and processing content. In addition, the information processing device may further include a selection unit that selects a determination method for competition, based on a result of a comparison between a priority of the new flow entry and priorities of flow entries chosen as the competitive candidates. In addition, in accordance with the selected determination method, the above-mentioned detection unit may detect a flow entry to compete with the new flow entry.

By doing so, it is possible to perform determination of competition, based on a relationship between priorities.

Furthermore, the above-mentioned selection unit may select a first determination method in a case where a priority of a flow entry chosen as one of the competitive candidates is higher than the priority of the new flow entry, the above-mentioned selection unit may select a second determination method in a case where the priority of the new flow entry is higher than the priority of the flow entry chosen as one of the competitive candidates, and furthermore, the above-mentioned selection unit may select a third determination method in a case where the priority of the flow entry chosen as one of the competitive candidates is equal to the priority of the new flow entry. In addition, in the first determination method, in a case where all lower-level conditions included in the above-mentioned condition of the flow entry chosen as one of the competitive candidates are each consistent with one of lower-level conditions included in the above-mentioned condition of the new flow entry, the above-mentioned detection unit may determine that the flow entry chosen as one of the competitive candidates competes with the new flow entry. In the second determination method, in a case where all the lower-level conditions of the new flow entry are each consistent with one of the lower-level conditions of the flow entry chosen as one of the competitive candidates, the above-mentioned detection unit may determine that the flow entry chosen as one of the competitive candidates competes with the new flow entry. In the third determination method, in a case where all the lower-level conditions of the new flow entry and all the lower-level conditions of the flow entry chosen as one of the competitive candidates are consistent with each other, the above-mentioned detection unit may determine that the flow entry chosen as one of the competitive candidates competes with the new flow entry.

By doing so, a relatively small amount of determination processing related to an inclusion relation between conditions is taken. Therefore, a processing load is reduced as a whole.

Furthermore, the above-mentioned choosing unit may choose competitive candidates by adding, to the choosing condition, (a) having a higher priority than that of the new flow entry and the above-mentioned condition including lower-level conditions the number of which is less than or equal to the number of the lower-level conditions included in the above-mentioned condition of the new flow entry, (b) having a lower priority than that of the new flow entry and the above-mentioned condition including lower-level conditions the number of which is greater than or equal to the number of the lower-level conditions of the new flow entry, or (c) having a priority equal to that of the new flow entry.

By doing so, the number of targets for comparisons with the new flow entry is further reduced. Therefore, a load on processing for detecting competition is further reduced.

A program for causing a computer to perform processing based on the above-mentioned method may be created. The relevant program may be stored in a computer-readable storage medium or storage device such as, for example, a flexible disk, a CD-ROM, a magneto-optical disk, a semiconductor memory, or a hard disk. In general, an intermediate processing result is temporarily stored in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method executed by a processor included in a computer, the computer including a memory that stores a plurality of flow entries in each of which a packet condition for choosing a packet, a processing content corresponding to the packet, and a type of the processing content are associated with one another, the information processing method comprising:
choosing, from the flow entries, one or more candidate flow entries respectively including a type different from the type included in a new flow entry, when storing the new flow entry;
detecting, from among the one or more candidate flow entries, a competitive flow entry having the processing content different from that of the new flow entry based on the packet condition; and
notifying another information processing device coupled to the information processing device of a result of the detecting.

2. The information processing method according to claim 1,
wherein the type includes transferring and discarding.

3. The information processing method according to claim 1, wherein
a priority is assigned to each of the new flow entry and the flow entries, and
the detecting includes:
selecting, based on a result of a comparison between the priority of the new flow entry and the priority of one of the candidate flow entries selected from the flow entries, a determination method for determining whether the corresponding one of the candidate flow entries is the competitive flow entry, and
detecting, in accordance with the selected determination method, the competitive flow entry from within the one or more candidate flow entries.

4. The information processing method according to claim 3, wherein the selecting the determination method includes
selecting a first determination method in a case where the priority of one of the candidate flow entries is higher than the priority of the new flow entry,
wherein the first determination method is a method for determining that the flow entry chosen as one of the candidates competes with the new flow entry, when all lower-level conditions included in the packet condition of the corresponding one of the candidate flow entries are each consistent with one of lower-level conditions included in the packet condition of the new flow entry

5. The information processing method according to claim 4, wherein the selecting the determination method includes
selecting a second determination method in a case where the priority of the new flow entry is higher than the priority of the corresponding one of the candidate flow entries,
wherein the second determination method is a method for determining that the corresponding one of the candidate flow entries competes with the new flow entry, when all the lower-level conditions of the new flow entry are each consistent with one of the lower-level conditions of the corresponding one of the candidate flow entries

6. The information processing method according to claim 5, wherein the selecting the determination method includes
selecting a third determination method when the priority of the corresponding one of the candidate flow entries is equal to the priority of the new flow entry,
wherein the third determination method is a method for determining that the corresponding one of the candidate flow entries competes with the new flow entry, when all the lower-level conditions of the new flow entry and all the lower-level conditions of the corresponding one of the candidate flow entries are consistent with each other.

7. The information processing method according to claim 3, wherein the choosing includes
choosing the one or more candidate flow entries which each have the priority higher than the priority of the new flow entry and for each of which the number of lower-level conditions included in the packet condition is less than or equal to the number of the lower-level conditions of the new flow entry.

8. The information processing method according to claim 3, wherein the choosing includes
choosing the one or more candidate flow entries which each have the priority lower than the priority of the new flow entry and for each of which the number of lower-level conditions included in the packet condition is greater than or equal to the number of the lower-level conditions of the new flow entry.

9. The information processing method according to claim 3, wherein the choosing includes
choosing the one or more candidate flow entries which each have the priority equal to the priority of the new flow entry.

10. An information processing device, comprising:
a memory that stores a plurality of flow entries in each of which a packet condition for choosing a packet, a processing content corresponding to the packet, and a type of the processing content are associated with one another; and
a processor coupled to the memory and configured to:
choose, from the flow entries, one or more candidate flow entries respectively including a type different from the type included in a new flow entry, when storing the new flow entry;
detect, from among the one or more candidate flow entries, a competitive flow entry having the processing content different from that of the new flow entry based on the packet condition; and
notify another information processing device coupled to the information processing device of the detected competitive flow entry.

11. The information processing device according to claim 10,
wherein the type includes transferring and discarding.

12. The information processing device according to claim 10, wherein
a priority is assigned to each of the new flow entry and the flow entries, and
the processor is configured to:
select, based on a result of a comparison between the priority of the new flow entry and the priority of one of the candidate flow entries selected from the flow entries, a determination method for determining whether the corresponding one of the candidate flow entries is the competitive flow entry, and
detect, in accordance with the selected determination method, the competitive flow entry from within the one or more candidate flow entries.
